(19) United States
(12) Patent Application Publication
(10) Pub. No.: US 2008/0167429 A1
(43) Pub. Date: Jul. 10, 2008

(54) Nanoimprinting composition

(75) Inventor: Hiroyuki Satou, Ichihara-shi (JP)

Correspondence Address: HOGAN & HARTSON LLP;IP GROUP, COLUMBIA SQUARE, 555 THIRTEENTH STREET, N.W., WASHINGTON, DC, 20004, US

(73) Assignee: CHISSO Corporation

(21) Appl. No.: 11/819,462

(22) Filed: Jun. 27, 2007

(30) Foreign Application Priority Data
Jun. 29, 2006 (JP) 2006-179299

(51) Int. Cl. C08L 77/12

(52) U.S. Cl. 525/423

(57) ABSTRACT

The invention provides a nanoimprinting composition that has good heat resistance and with which a relief pattern that has been formed is not readily eliminated by heating. A relief pattern can be formed easily and efficiently in this nanoimprinting composition. This is accomplished by a nanoimprinting composition including a polyamic acid (B) and an epoxy resin (C), and also accomplished by a nanoimprinting composition including a polyester-polyamic acid (A1) and an epoxy resin (C).

### CROSS REFERENCE TO RELATED APPLICATIONS

This application claims priority under 35 U.S.C. § 119 to Japanese Patent Application No. JP 2006-179299, filed Jun. 29, 2006, which is expressly incorporated herein by reference in its entirety.

### BACKGROUND OF THE INVENTION

1. Field of the Invention

The invention relates to a nanoimprinting composition, and more particularly relates to a material used in nanoimprinting technology for transferring a fine textured pattern to a substrate surface by pressing a platen against the surface.

2. Related Art

As precision microfabrication technology, nanoimprinting technology is known. This microfabrication technology includes technology of thermal imprinting. Thermal imprinting generally involves the steps of (1) pressing a mold into a polymer film made of polymethyl methacrylate or another such thermoplastic resin on a substrate under decompression, (2) heating the substrate to over the glass transition temperature of a resist, (3) cooling the mold and the substrate to room temperature after a specific amount of time has elapsed, (4) separating the mold from the substrate, and (5) forming a relief pattern on the polymer film (see Japanese Laid-Open Patent Application 2006-110956).

However, a problem was that the relief pattern formed on a polymer film made of thermoplastic resins such as polymethyl methacrylate is very susceptible to being eliminated by heating. Another problem was that the mold has to be kept pressed against the surface for a long time to form the relief pattern.

In light of the above situation, there has been a need for a nanoimprinting composition that has good heat resistance and with which a relief pattern that has been formed is not readily eliminated by heating. There has also been a need for a way to form a relief pattern in a nanoimprinting composition easily and efficiently.

### SUMMARY OF THE INVENTION

It has been observed that a composition obtained by adding a polyamic acid (including a polyester-polyamic acid) and an epoxy resin to a thermoplastic polymer resin formed on a substrate can be used for nanoimprinting.

The invention provides the following nanoimprinting composition, etc.

[1] A nanoimprinting composition including a polyamic acid (B) and an epoxy resin (C).

[2] The nanoimprinting composition according to item [1], wherein the polyamic acid (B) has structural units expressed by the following General Formula (1):

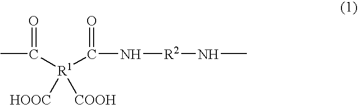

wherein R¹ and R² are each independently a C₂ to C₁₀₀ organic group.

[3] The nanoimprinting composition according to items [1] or [2], wherein the polyamic acid (B) is obtained using a diamine and a tetracarboxylic dianhydride.

[4] The nanoimprinting composition according to item [1], wherein the polyamic acid (B) is obtained using one or more diamines selected from the group of 4,4′-diaminodiphenylsulfone, 3,3′-diaminodiphenylsulfone, 3,4′-diaminodiphenylsulfone, bis[4-(4-aminophenoxy)phenyl]sulfone, bis[4-(3-aminophenoxy)phenyl]sulfone, bis[3-(4-aminophenoxy)phenyl]sulfone, [4-(4-aminophenoxy)phenyl][3-(4-aminophenoxy)phenyl]sulfone, [4-(3-aminophenoxy)phenyl][3-(4-aminophenoxy)phenyl]sulfone, 4,4′-diaminodiphenyl ether, 4,4′-diaminodiphenylmethane, 3,3′-diaminodiphenylmethane, 3,3′-dimethyl4,4′-diaminodiphenylmethane, 2,2-bis[4-(4-aminophenoxy)phenyl]propane, 2,2-bis[4-(4-aminophenoxy)phenyl]hexafluoropropane, and compounds expressed by the following Formula (b):

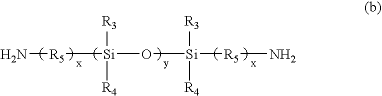

wherein R₃ and R₄ are each independently a C₁ to C₃ alkyl or phenyl, each R₅ is independently a methylene, phenylene, or alkyl-substituted phenylene, each x is independently an integer from approximately 1 to approximately 6, and y is an integer from approximately 1 to approximately 100; and

one or more tetracarboxylic dianhydrides selected from the group of pyromellitic dianhydride, 1,2,3,4-cyclobutanetetracarboxylic dianhydride, 1,2,3,4-butanetetracarboxylic dianhydride, 1,2,4,5-cyclohexanetetracarboxylic dianhydride, 3,3′,4,4′-diphenyl ether tetracarboxylic dianhydride, and 3,3′,4,4′-diphenylsulfonetetracarboxylic dianhydride.

[5] The nanoimprinting composition according to any of items [1] to [3], wherein the epoxy resin (C) is one or more compounds selected from the group of compounds expressed by the following Formulas (220) to (223):

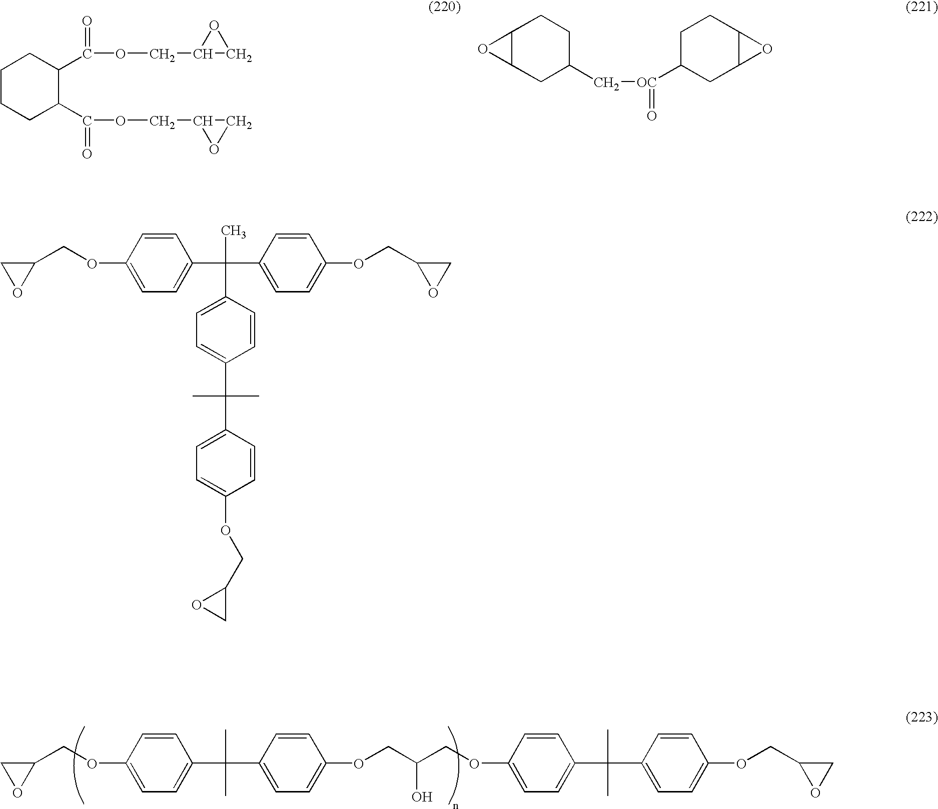

wherein n is an integer from approximately 0 to approximately 10.

[6] The nanoimprinting composition according to any of items [1] to [5], wherein the polyamic acid (B) is contained in an amount of approximately 1 to approximately 50 wt %, and the epoxy resin (C) approximately 1 to approximately 50 wt %.

[7] A nanoimprinting composition, including approximately 2 to approximately 40 wt % of a polyamic acid (B) obtained by reacting one or more diamines selected from the group of 4,4′-diaminodiphenylsulfone, 3,3′-diaminodiphenylsulfone, 4,4′-diaminodiphenyl ether, 4,4′-diaminodiphenylmethane, 3,3′-diaminodiphenylmethane, 2,2-bis[4-(4-aminophenoxy)phenyl]hexafluoropropane, and compounds expressed by the following Formula (b):

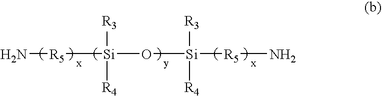

wherein R₃ and R₄ are each independently a C₁ to C₃ alkyl or phenyl, each R₅ is independently a methylene, phenylene, or alkyl-substituted phenylene, each x is independently an integer from approximately 1 to approximately 6, and y is an integer from approximately 1 to approximately 100;

with one or more tetracarboxylic dianhydrides selected from the group of pyromellitic dianhydride, 1,2,3,4-butanetetracarboxylic dianhydride, 3,3′,4,4′-diphenyl ether tetracarboxylic dianhydride, and 3,3′,4,4′-diphenylsulfonetetracarboxylic dianhydride; and

approximately 2 to approximately 40 wt % one or more epoxy resins (C) selected from the group of compounds expressed by the following Formulas (220) to (223):

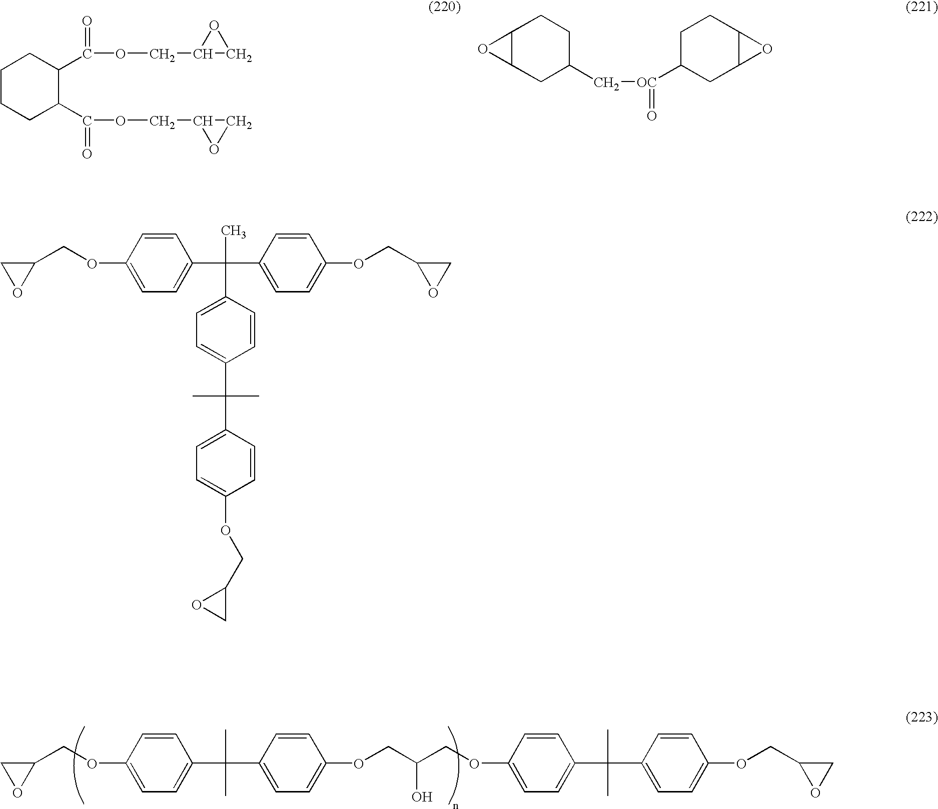

wherein n is an integer from approximately 0 to approximately 10.

[8] A nanoimprinting composition including one or more compounds selected from the group of polyester-polyamic acids (A1) having structural units expressed by the following General Formulas (1) and (2):

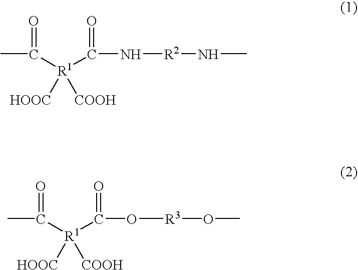

wherein R¹, R², and R³ are each independently a C₂ to C₁₀₀ organic group;

polyester-polyimides (A2) having structural units expressed by the following General Formulas (3) and (2):

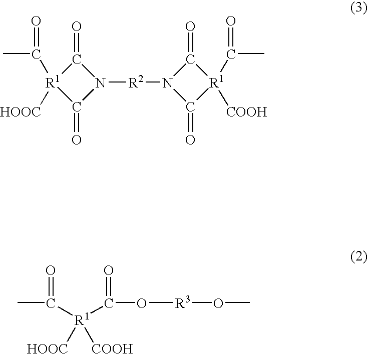

wherein R¹, R², and R³ are each independently a C₂ to C₁₀₀ organic group; and

an epoxy resin (C).

[9] A nanoimprinting composition including one or more compounds selected from the group of polyester-polyamic acids (A1) obtained using a polyhydric hydroxy compound (a1), a diamine (a2) and a compound having two or more acid anhydride groups (a3), and polyester-polyimides (A2) that are imidization products thereof, and an epoxy resin (C).

[10] The nanoimprinting composition according to item [9], wherein the polyester-polyamic acid (A1) has structural units expressed by the following General Formulas (1) and (2):

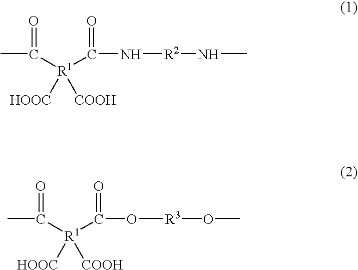

wherein R¹, R², and R³ are each independently a C₂ to C₁₀₀ organic group.

[11] The nanoimprinting composition according to items [9] or [10], wherein the polyester-polyimides (A2) have structural units expressed by the following General Formulas (3) and (2):

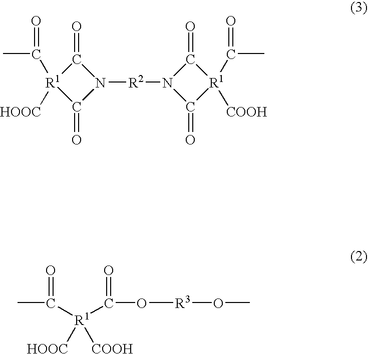

wherein R¹, R², and R³ are each independently a C₂ to C₁₀₀ organic group.

[12] The nanoimprinting composition according to any of items [9] to [11], wherein the compound having two or more acid anhydride groups (a3) is one or more compounds selected from the group of tetracarboxylic dianhydrides and copolymers of a polymerizable monomer having an acid anhydride group and another polymerizable monomer.

[13] The nanoimprinting composition according to item [12], wherein the polymerizable monomer having an acid anhydride group is maleic anhydride.

[14] The nanoimprinting composition according to items [12] or [13], wherein the other polymerizable monomer is one or more compounds selected from the group of styrene, methyl (meth)acrylate, butyl (meth)acrylate, 2-hydroxyethyl (meth)acrylate, benzyl (meth)acrylate, cyclohexyl (meth)acrylate, N-cyclohexyl maleimide, and N-phenylmaleimide.

[15] The nanoimprinting composition according to item [12], wherein the copolymer of a polymerizable monomer having an acid anhydride group and another polymerizable monomer is a copolymer of styrene and maleic anhydride.

[16] The nanoimprinting composition according to any of items [9] to [11], wherein the polyhydric hydroxy compound (a1) is one or more compounds selected from the group of ethylene glycol, diethylene glycol, triethylene glycol, tetraethylene glycol, propylene glycol, dipropylene glycol, tripropylene glycol, tetrapropylene glycol, 1,4-butanediol, 1,5-pentanediol, 1,6-hexanediol, glycerol, trimethylolpropane, pentaerythritol, and dipentaerythritol;

wherein the diamine (a2) is one or more compounds selected from the group of 4,4′-diaminodiphenylsulfone, 3,3′-diaminodiphenylsulfone, 3,4′-diaminodiphenylsulfone, bis[4-(4-aminophenoxy)phenyl]sulfone, bis[4-(3-aminophenoxy)phenyl]sulfone, bis[3-(4-aminophenoxy)phenyl]sulfone, [4-(4-aminophenoxy)phenyl], [3-(4-aminophenoxy)phenyl]sulfone, [4-(3-aminophenoxy)phenyl][3-(4-aminophenoxy)phenyl]sulfone, 4,4′-diaminodiphenyl ether, 4,4′-diaminodiphenylmethane, 3,3′-diaminodiphenylmethane, 3,3′-dimethyl-4,4′-diaminodiphenylmethane, 2,2-bis[4-(4-aminophenoxy)phenyl]propane, 2,2-bis[4-(4-aminophenoxy)phenyl]hexafluoropropane, and compounds expressed by the following Formula (b):

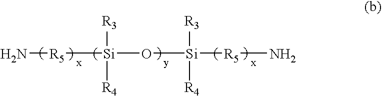

wherein R₃ and R₄ are each independently a C₁ to C₃ alkyl or phenyl, each R₅ is independently a methylene, phenylene, or alkyl-substituted phenylene, each x is independently an integer from approximately 1 to approximately 6, and y is an integer from approximately 1 to approximately 100; and

wherein the compound having two or more acid anhydride groups (a3) is one or more compounds selected from the group of styrene/maleic anhydride copolymers, pyromellitic dianhydride, 1,2,3,4-cyclobutanetetracarboxylic dianhydride, 1,2,3,4-butanetetracarboxylic dianhydride, 1,2,4,5-cyclohexanetetracarboxylic dianhydride, 3,3′,4,4′-diphenyl ether tetracarboxylic dianhydride, and 3,3′,4,4′-diphenylsulfonetetracarboxylic dianhydride.

[17] The nanoimprinting composition according to any of items [9] to [ 11], wherein the polyhydric hydroxy compound (a1) is one or more compounds selected from the group of 1,4-butanediol, 1,5-pentanediol, and 1,6-hexanediol;

wherein the diamine (a2) is one or more compounds selected from the group of 3,3′-diaminodiphenylsulfone, 4,4′-diaminodiphenyl ether, 4,4′-diaminodiphenylmethane, and compounds expressed by the following Formula (b):

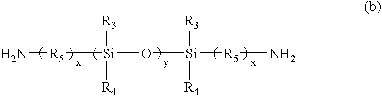

wherein R₃ and R₄ are each independently a C₁ to C₃ alkyl or phenyl, each R₅ is independently a methylene, phenylene, or alkyl-substituted phenylene, each x is independently an integer from approximately 1 to approximately 6, and y is an integer from approximately 1 to approximately 100); and

wherein the compound having two or more acid anhydride groups (a3) is one or more compounds selected from the group of styrene/maleic anhydride copolymers, 3,3′,4,4′-diphenyl ether tetracarboxylic dianhydride, 3,3′,4,4′-diphenylsulfonetetracarboxylic dianhydride, and butanetetracarboxylic dianhydride.

[18] The nanoimprinting composition according to any of items [9] to [17], wherein the polyester-polyamic acid (A1) or polyester-polyimides (A2) is obtained by reacting approximately 0.1 to approximately 10 mol of the amino groups of a diamine (a2) and approximately 1 to approximately 10 mol of an anhydride of a compound having two or more acid anhydride groups (a3) with approximately 1 mol of the hydroxy groups of a polyhydric hydroxy compound (a1).

[19] The nanoimprinting composition according to any of items [8] to [18], wherein the epoxy resin (C) is one or more compounds selected from the group of compounds expressed by the following Formulas (220) to (223):

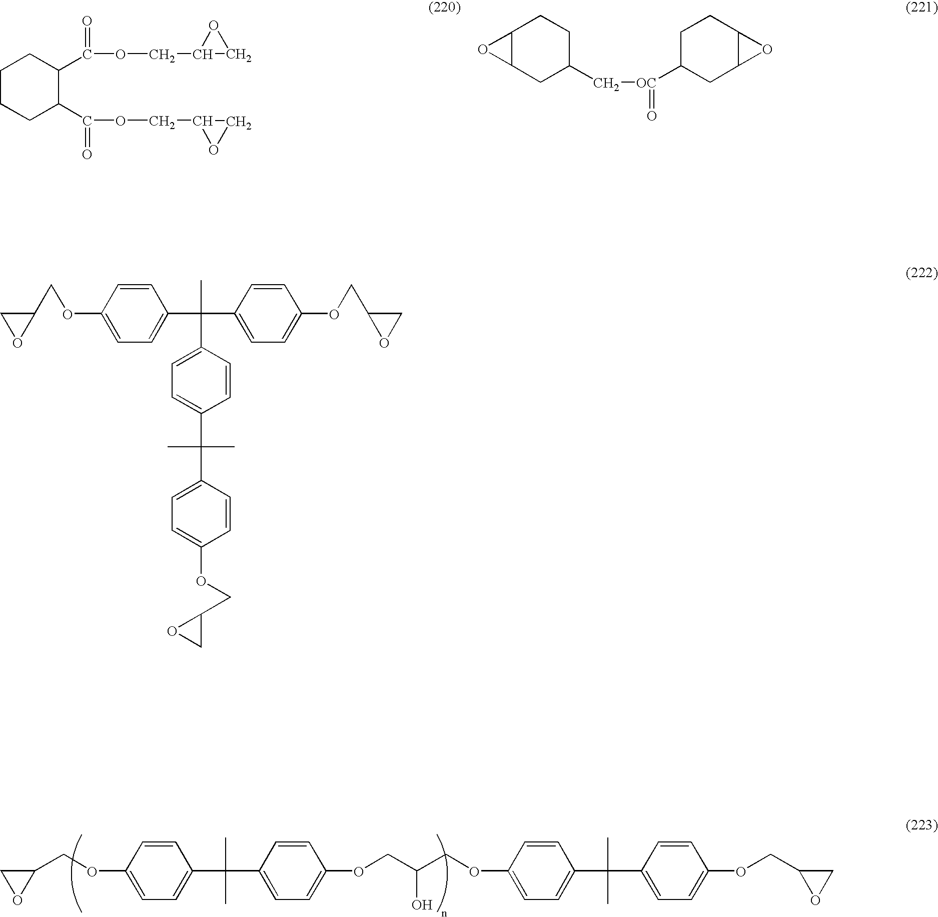

wherein n is an integer from approximately 0 to approximately 10.

[20] The nanoimprinting composition according to any of items [8] to [19], including the polyester-polyamic acid (A1) or the polyester-polyimide (A2) in an amount of approximately 1 to approximately 50 wt % and the epoxy resin (C) in an amount of approximately 1 to approximately 50 wt %.

[21] A nanoimprinting composition, including approximately 2 to approximately 40 wt % of a polyester-polyamic acid (A1) or polyester-polyimide (A2) obtained by reacting at least one compound of polyhydric hydroxy compound (a1) selected from the group of diethylene glycol, 1,4-butanediol, and trimethylolpropane, at least one compound of diamine (a2) selected from the group of 4,4′-diaminodiphenylsulfone, 4,4′-diaminodiphenyl ether, 4,4′-diaminodiphenylmethane and compounds expressed by Formula (b), and a compound having two or more of at least one compound of acid anhydride group (a3) selected from the group of styrene/maleic anhydride copolymers, pyromellitic dianhydride, 1,2,3,4-butanetetracarboxylic dianhydride, 3,3′,4,4′-diphenyl ether tetracarboxylic dianhydride, and 3,3′,4,4′-diphenylsulfonetetracarboxylic dianhydride, and at least one epoxy resin of approximately 2 to approximately 40 wt % (C) selected from the group of compounds expressed by the following Formulas (220) to (223):

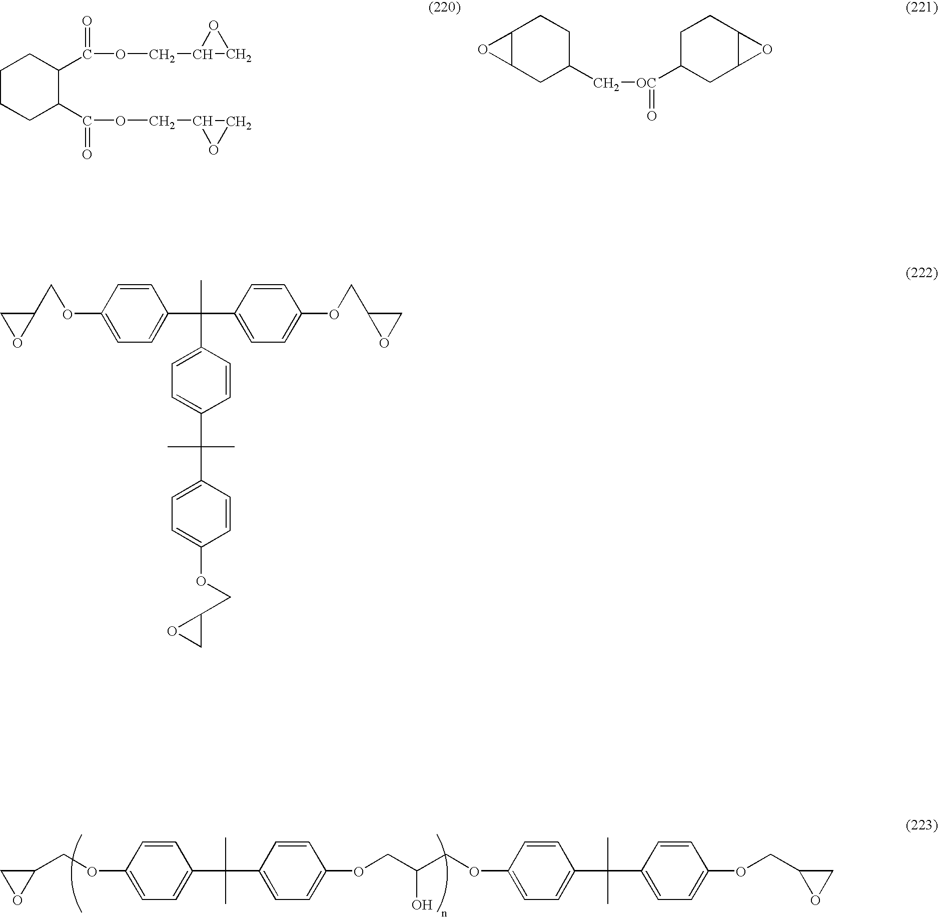

wherein n is an integer from approximately 0 to approximately 10.

[22] The nanoimprinting composition according to any of items [8] to [21], further including a polyamic acid (B).

In this Specification, the “alkyl” in “alkyl-substituted phenylene” is preferably a C₂ to C₁₀ alkyl, and even more preferably a C₂ to C₆ alkyl. Examples of alkyls include ethyl, propyl, isopropyl, butyl, s-butyl, t-butyl, pentyl, hexyl, and dodecanyl, although this list is not meant to be comprehensive.

The nanoimprinting composition pertaining to a preferred embodiment of the invention can provide a polymer film that has good heat resistance and with which a relief pattern that has been formed is not readily eliminated by heating.

When a nanoimprinting composition pertaining to a preferred embodiment of the invention is used, a relief pattern can be formed at a lower mold pressing temperature than in the past, for example. Also, when a nanoimprinting composition pertaining to a preferred embodiment of the invention is used, pressing the mold will take less time than in the past, so the relief pattern can be produced more easily and efficiently. Furthermore, a nanoimprinting composition pertaining to a preferred embodiment of the invention has good chemical resistance.

### DESCRIPTION OF THE PREFERRED EMBODIMENTS

The invention provides a nanoimprinting composition including a polyamic acid (B) and an epoxy resin (C). The invention also provides a nanoimprinting composition including at least one compound selected from the group of polyester-polyamic acids (A1) and polyester-polyimides (A2) that are imidization products thereof and an epoxy resin (C).

1. Polyamic Acid (B)

The polyamic acid (B) is a compound having structural units expressed by the above-mentioned Formula (1). R¹ and R² in Formula (1) are each independently a C₂ to C₁₀₀ organic group, but there are no other particular restrictions on them.

There are no particular restrictions on the concentration of the polyamic acid (B) in the nanoimprinting composition in the invention, approximately 1 to approximately 50 wt % is preferable, and approximately 2 to approximately 40 wt % is even better. It is preferable for the concentration to be within these ranges because the nanoimprinting composition will have the ideal viscosity, allowing coating film of uniform thickness to be formed by a variety of coating methods.

The polyamic acid (B) is obtained, for example, by reacting a diamine with a compound having two or more acid anhydride groups.

1.1. Diamine Used in Synthesis of Polyamic Acid (B)

There are no particular restrictions on the diamine used in the synthesis of the polyamic acid (B) in the invention, but specific examples include 4,4′-diaminodiphenylsulfone, 3,3′-diaminodiphenylsulfone, 3,4′-diaminodiphenylsulfone, bis[4-(4-aminophenoxy)phenyl]sulfone, bis[4-(3-aminophenoxy)phenyl]sulfone, bis[3-(4-aminophenoxy)phenyl]sulfone, [4-(4-aminophenoxy)phenyl][3-(4-aminophenoxy)phenyl]sulfone, [4-(3-aminophenoxy)phenyl][3-(4-aminophenoxy)phenyl]sulfone, compounds expressed by the above-mentioned Formula (b), 4,4′-diaminodiphenylmethane, 3,3′-diaminodiphenylmethane, 3,3′-dimethyl-4,4′-diaminodiphenylmethane, 2,2-bis[4-(4-aminophenoxy)phenyl]propane, 2,2-bis[4-(4-aminophenoxy)phenyl]hexafluoropropane, m-phenylenediamine, p-phenylenediamine, m-xylylenediamine, p-xylylenediamine, 2,2′-diaminodiphenylpropane, benzidine, 1,1-bis[4-(4-aminophenoxy)phenyl]cyclohexane, 1,1-bis[4-(4-aminophenoxy)phenyl]-4-methylcyclohexane, bis[4-(4-aminobenzyl)phenyl]methane, 1,1-bis[4-(4-aminobenzyl)phenyl]cyclohexane, 1,1-bis[4-(4-aminobenzyl)phenyl]-4-methylcyclohexane, 1,1-bis[4-(4-aminobenzyl)phenyl]cyclohexane, 1,1-bis[4-(4-aminobenzyl)phenyl]-4-methylcyclohexane, 1,1-bis[4-(4-aminobenzyl)phenyl]methane, and compounds expressed by the following Formulas (1) to (172).

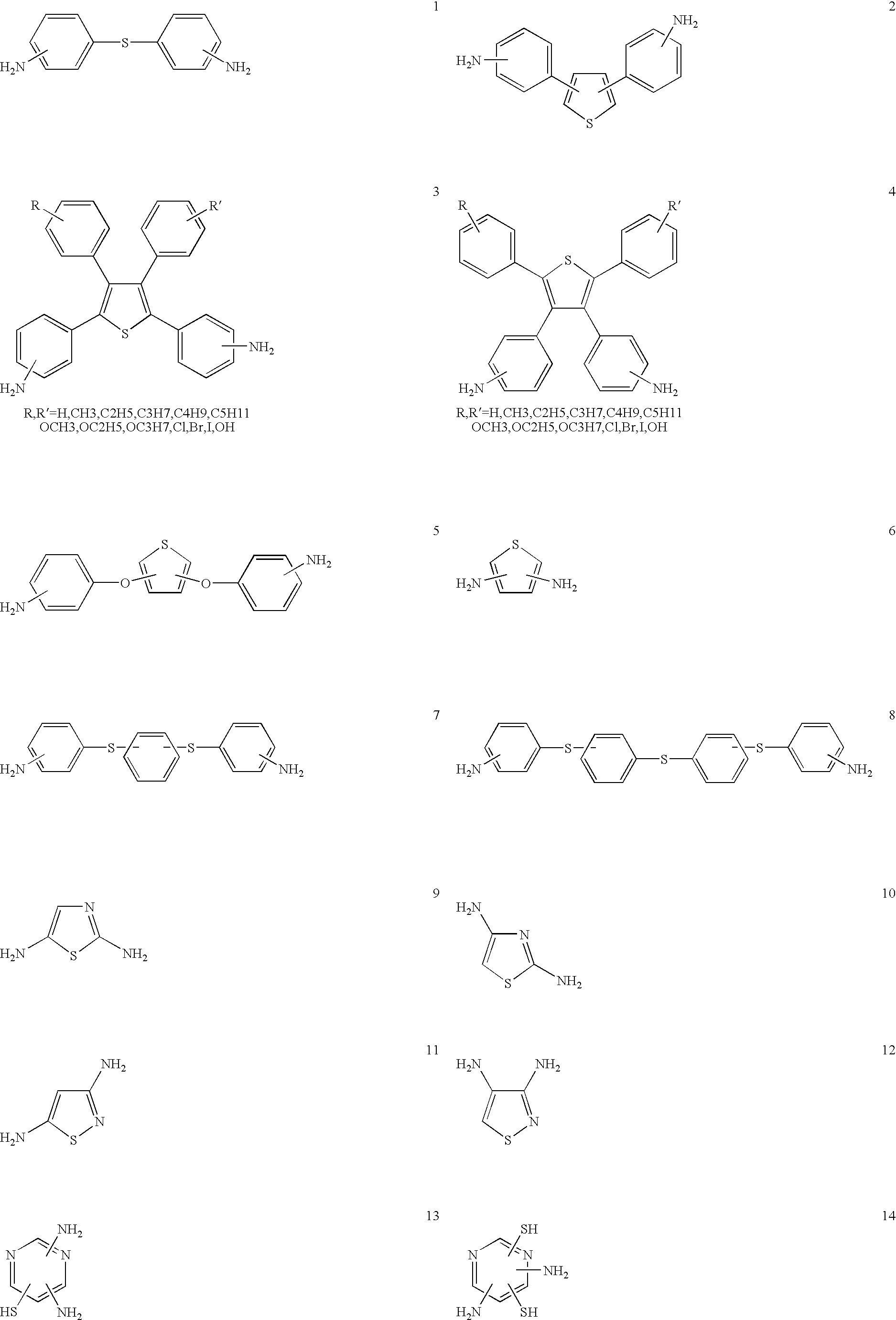

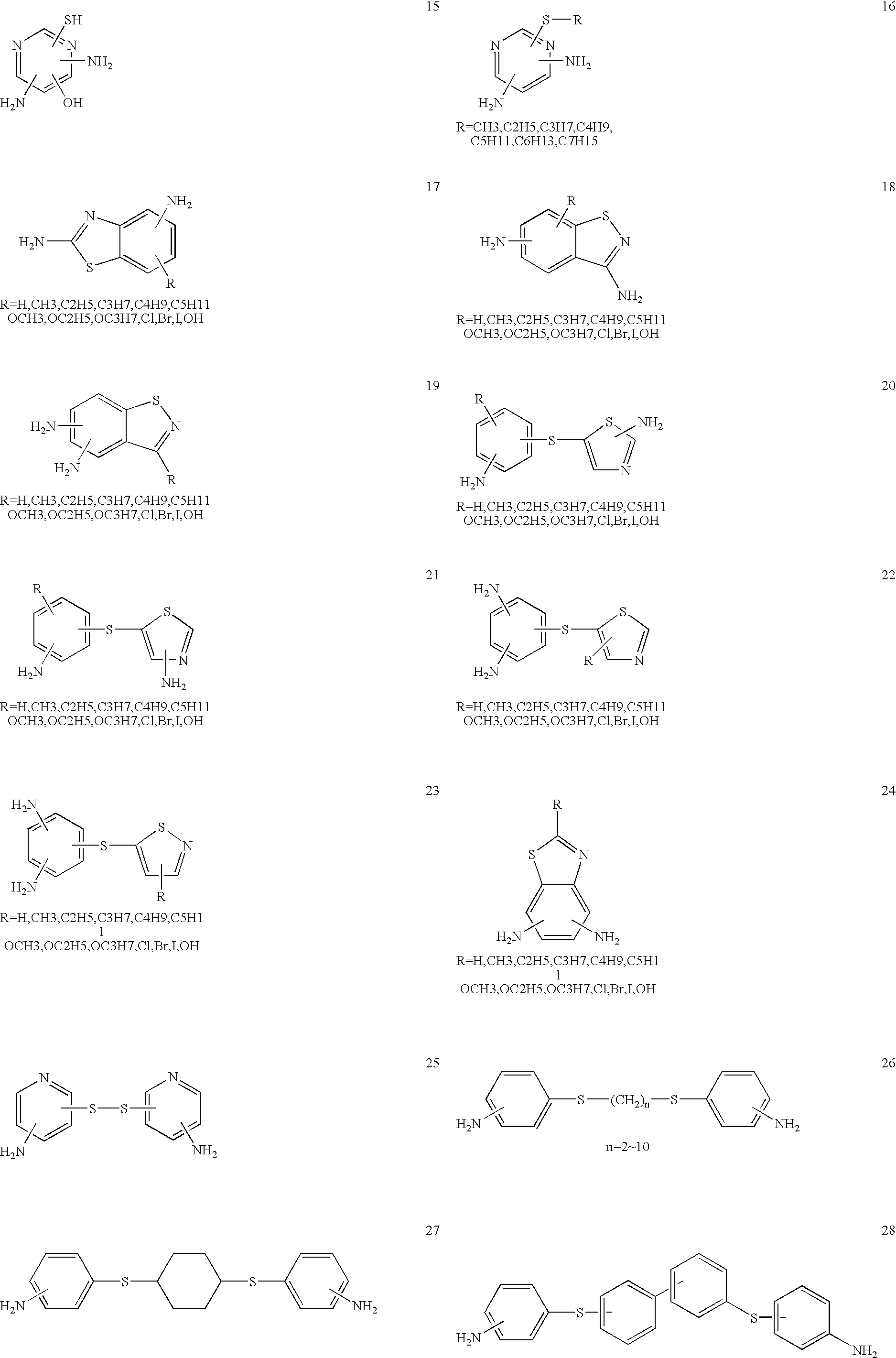

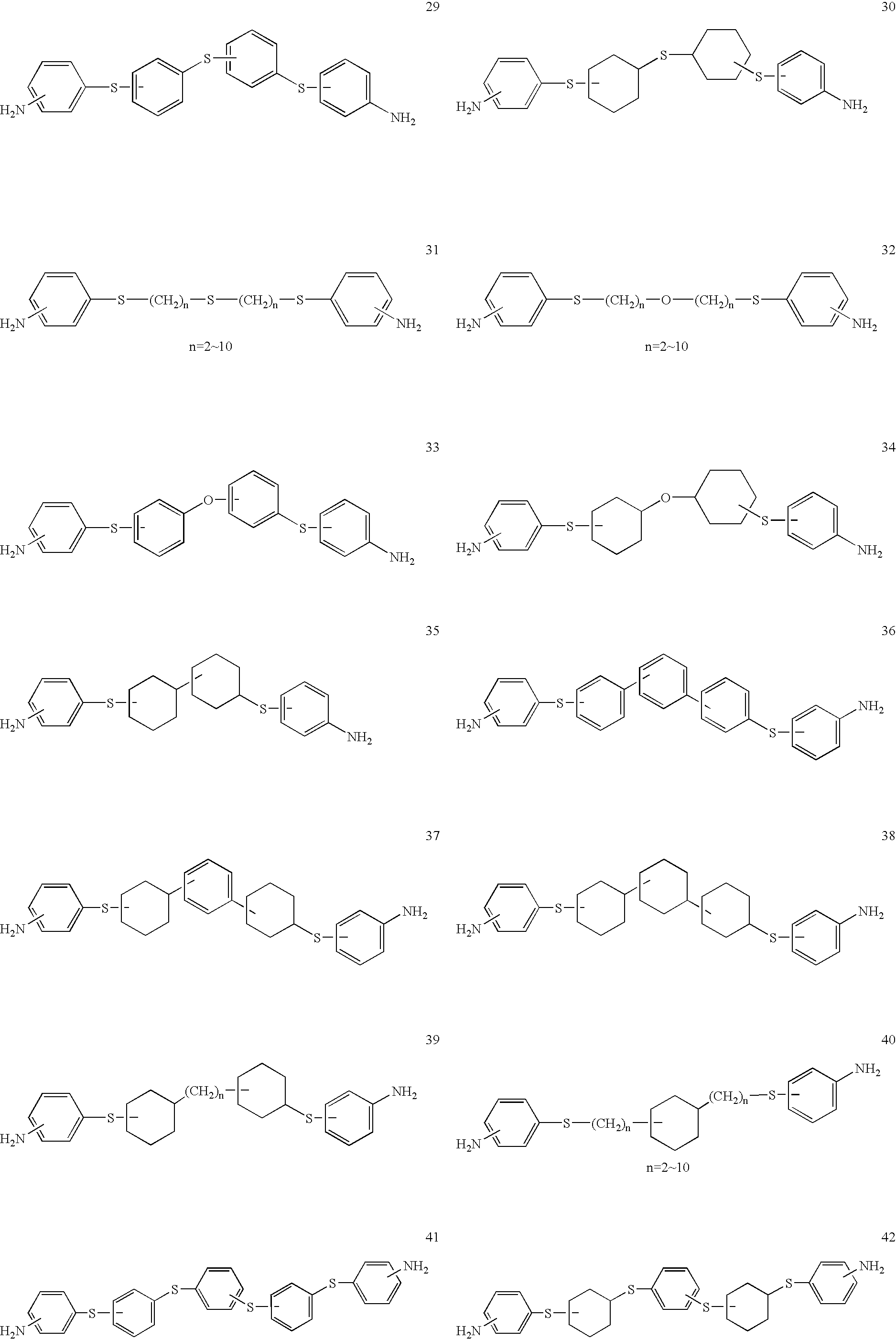

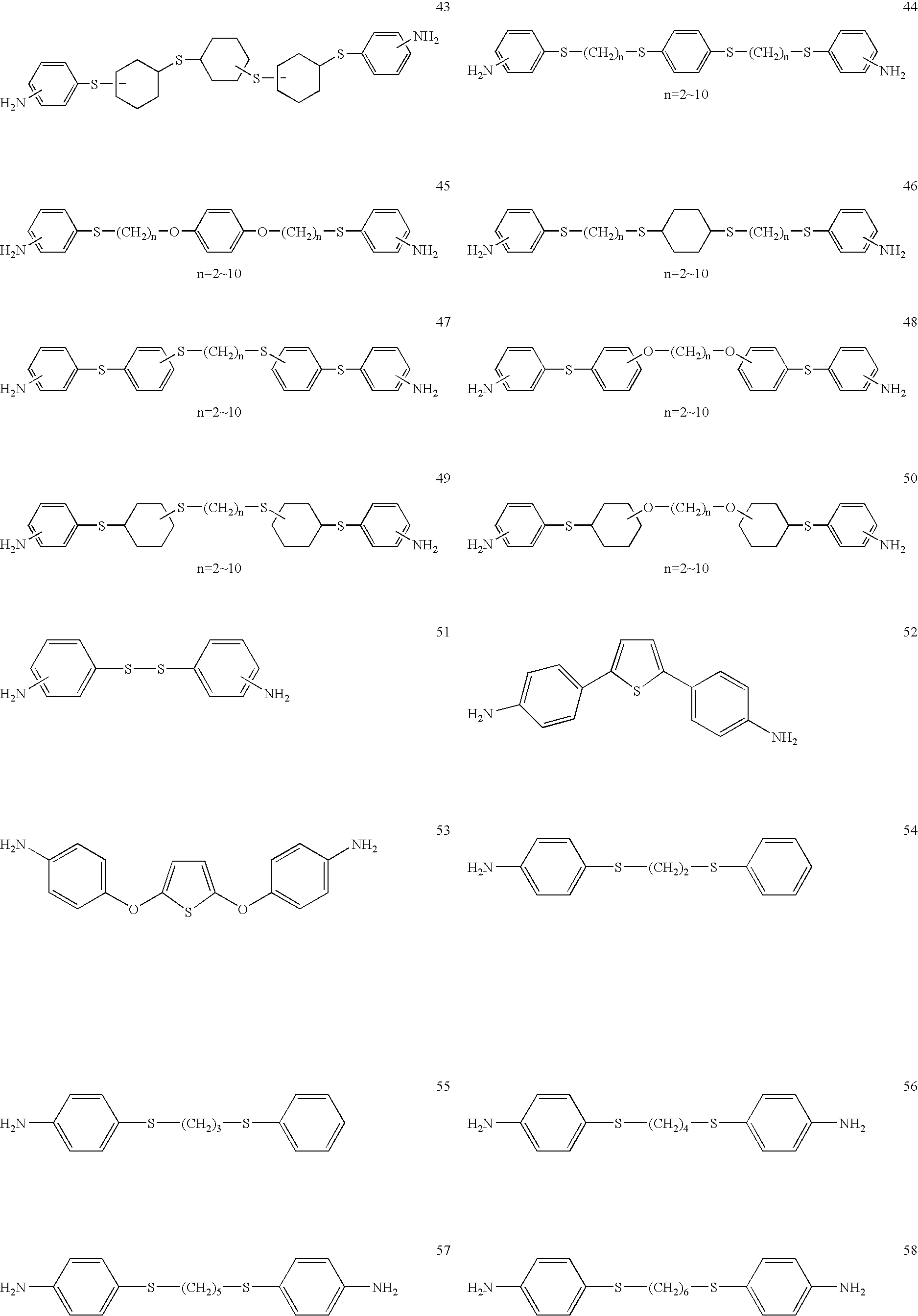

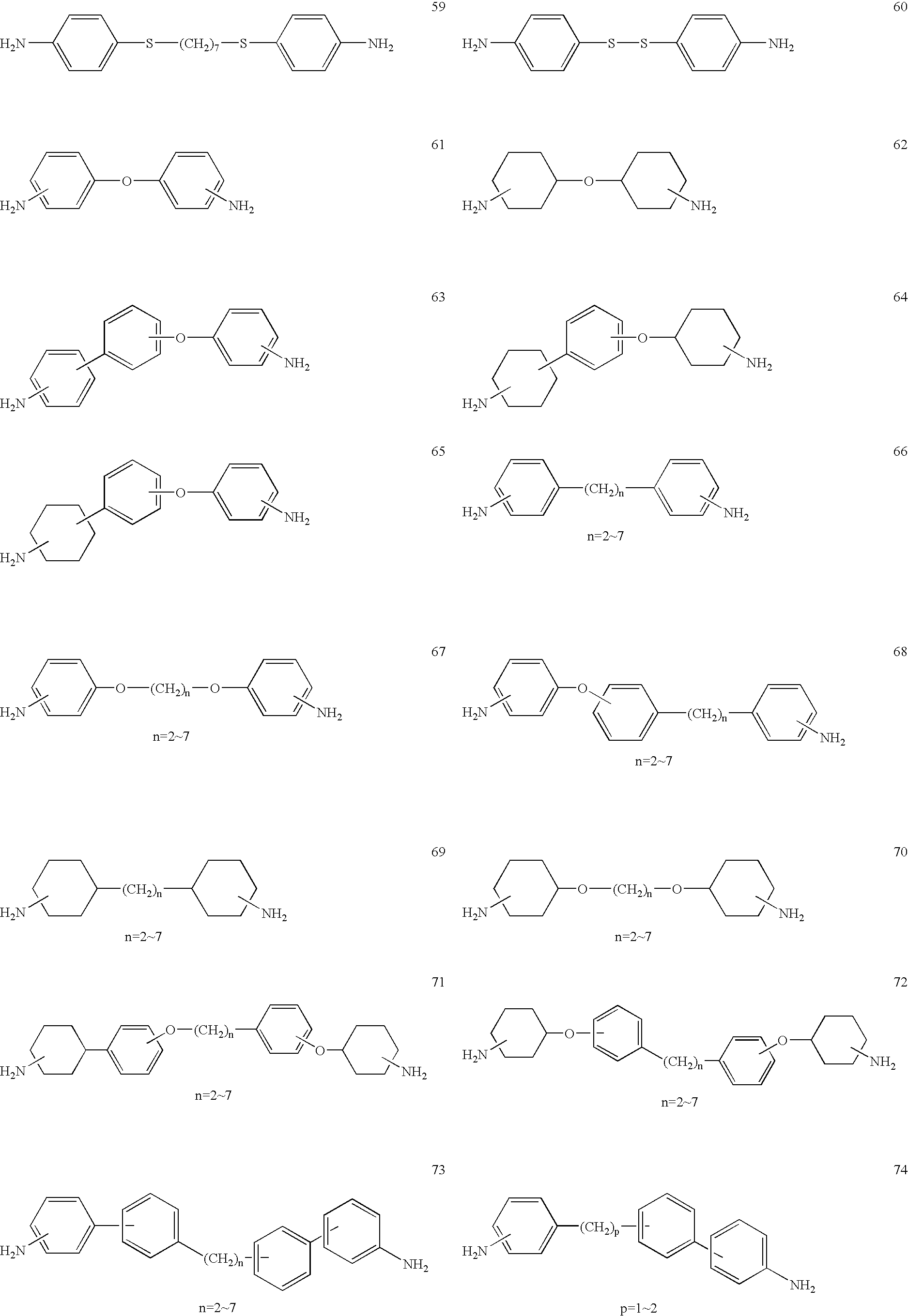

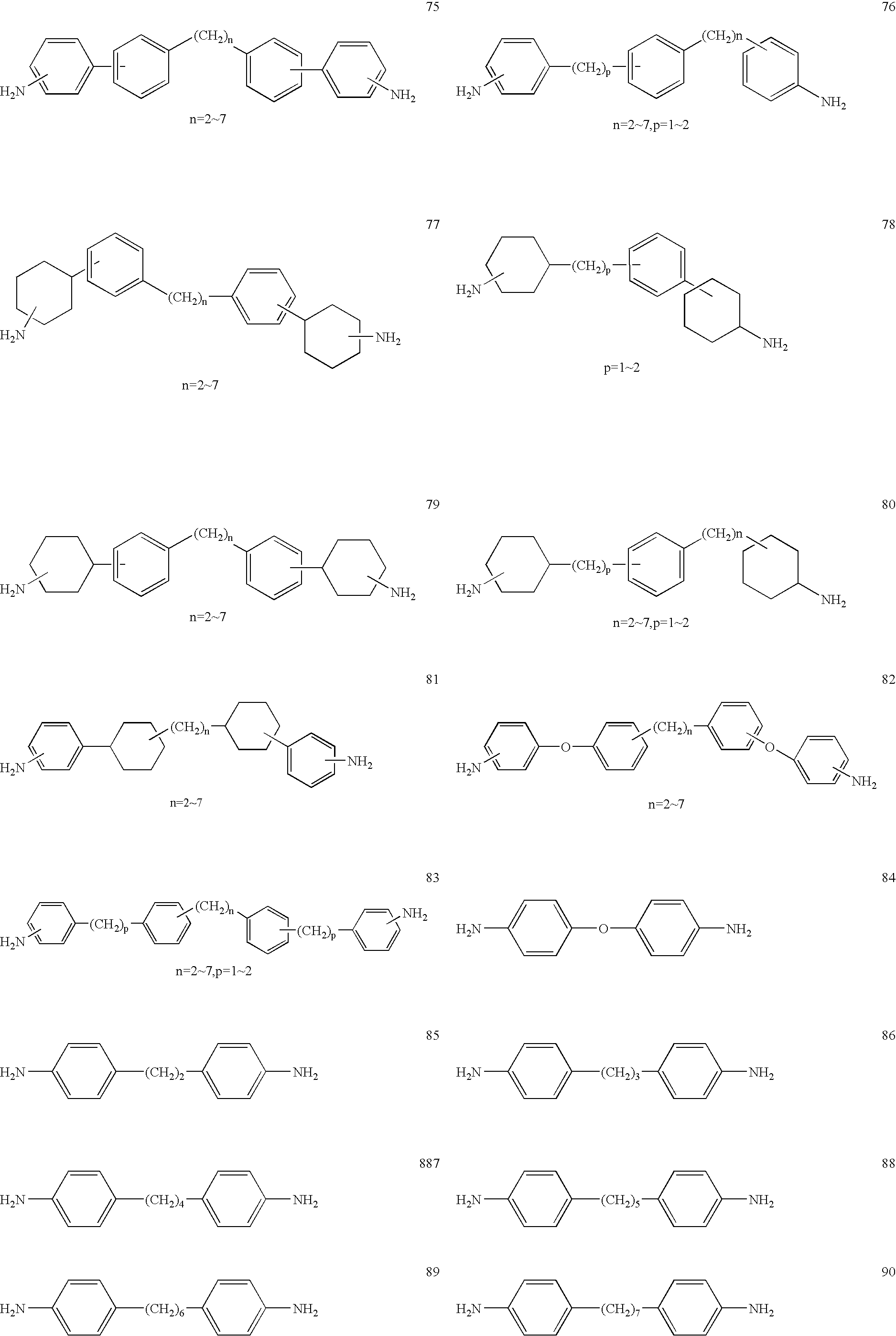

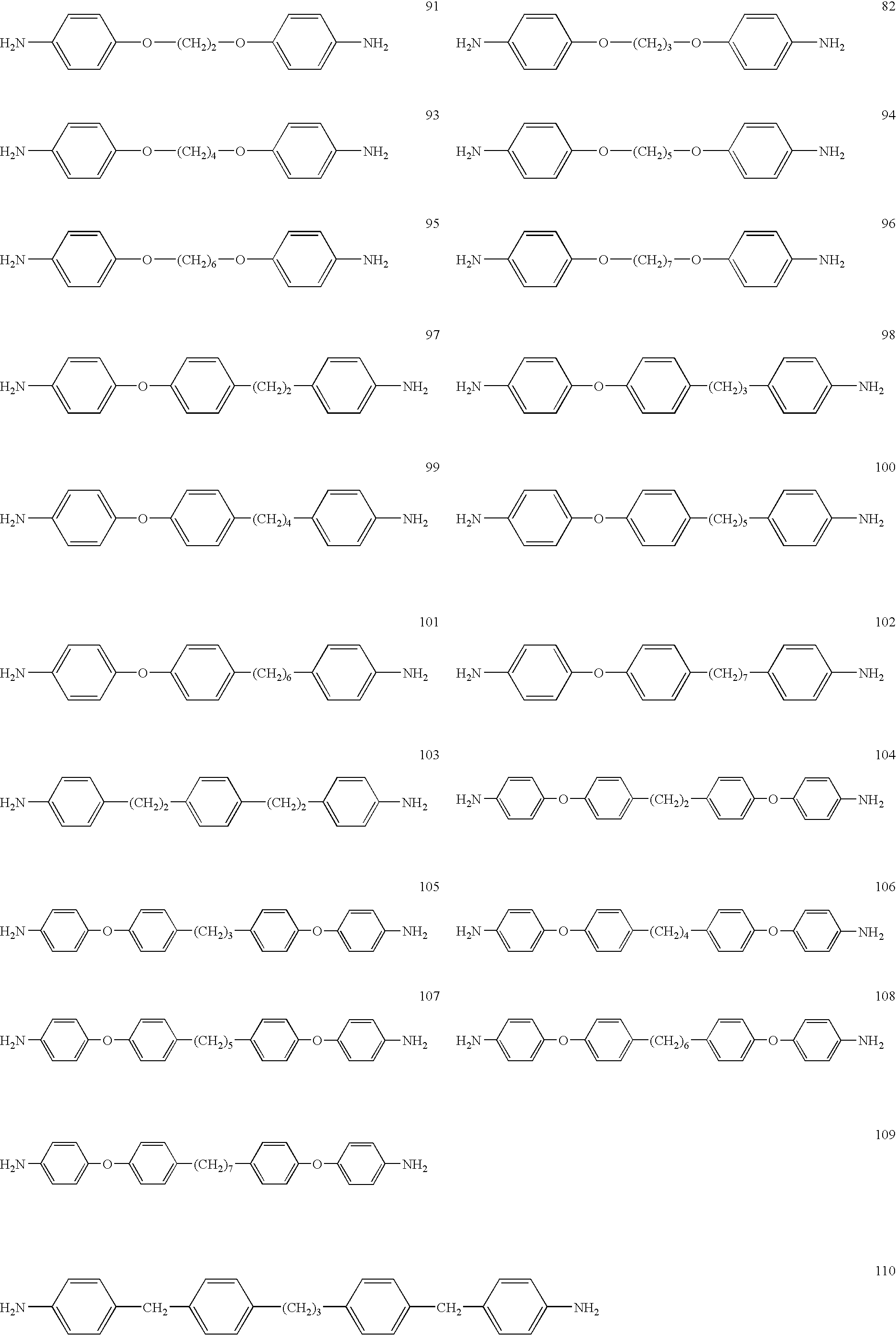

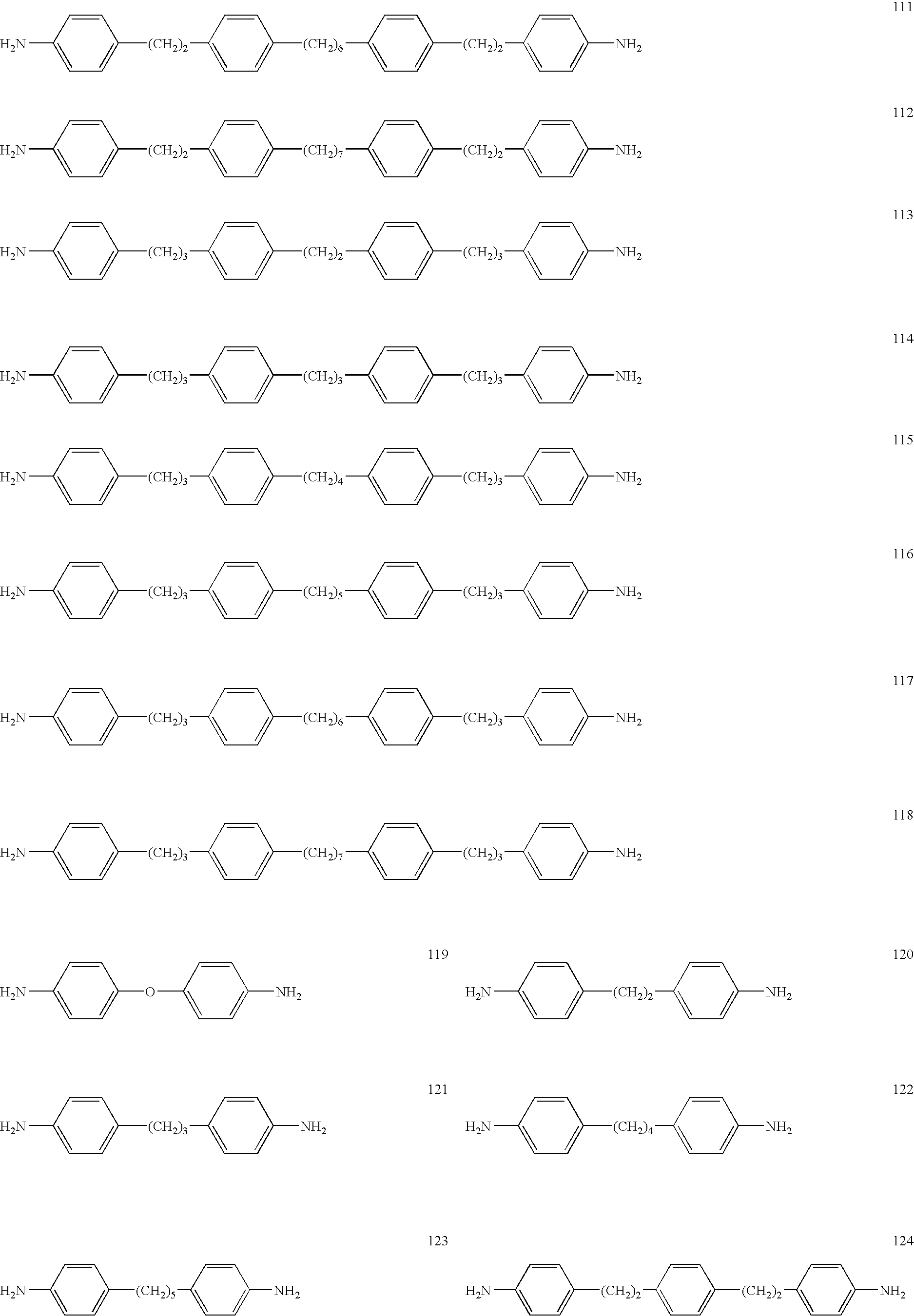

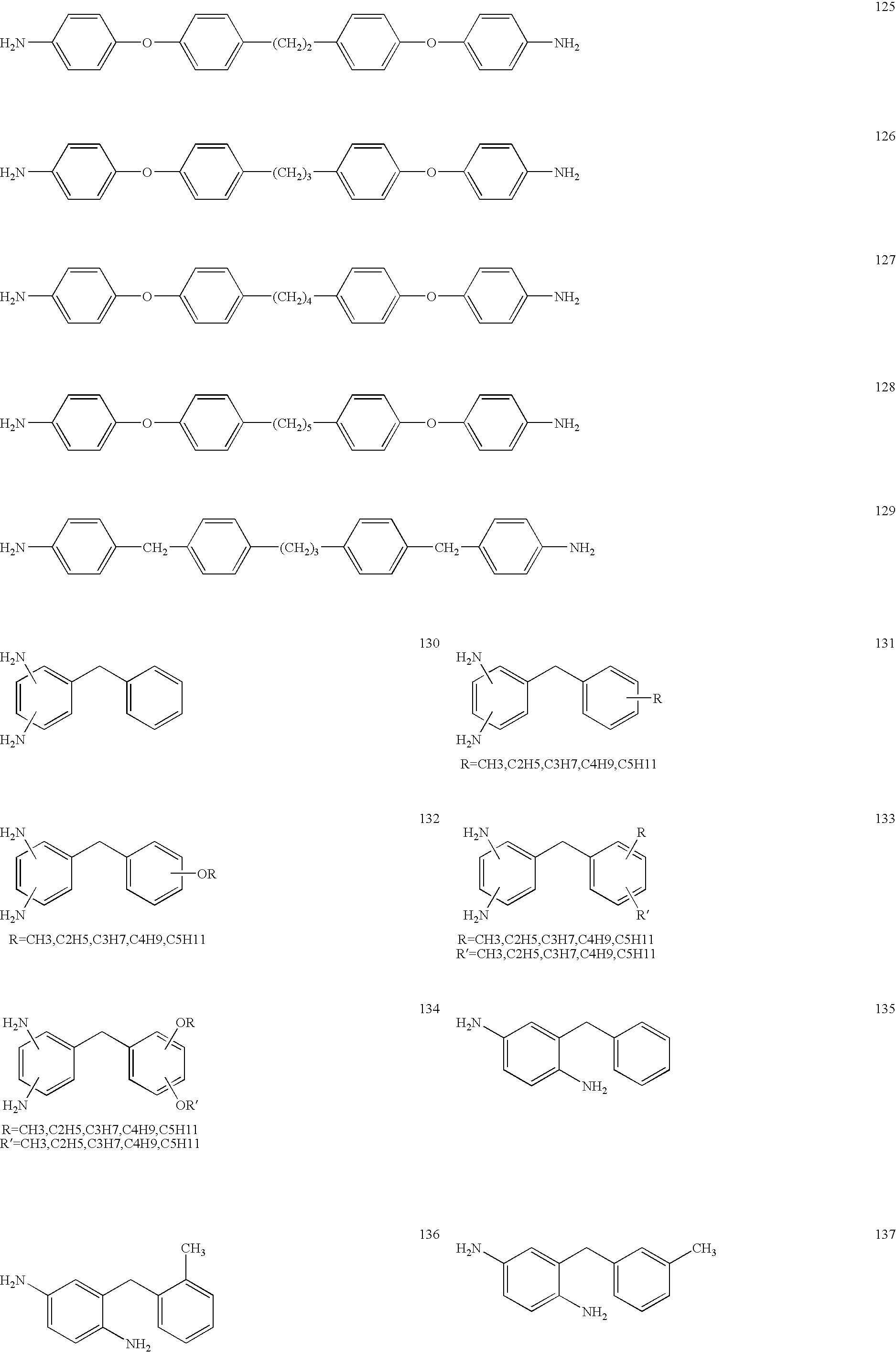

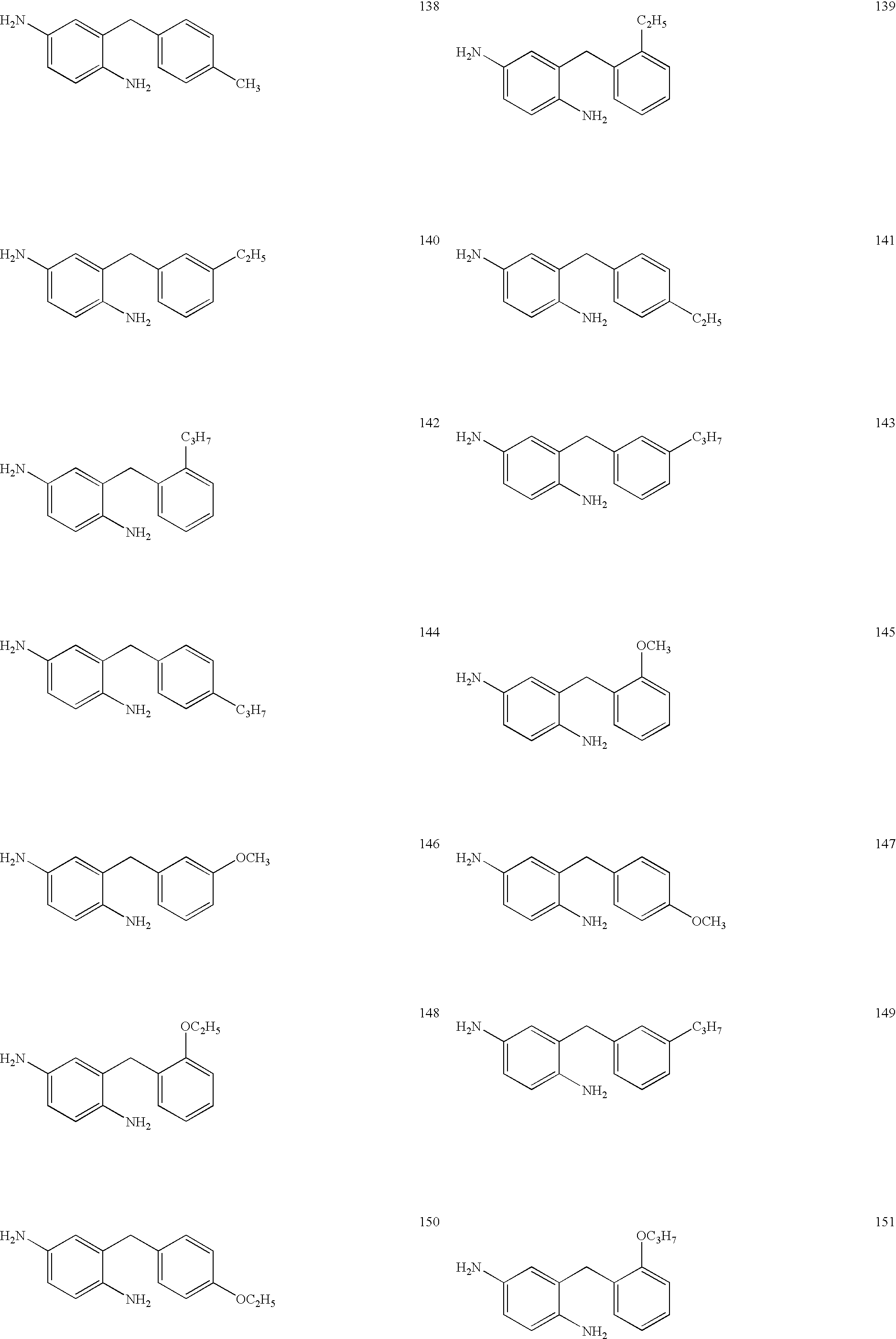

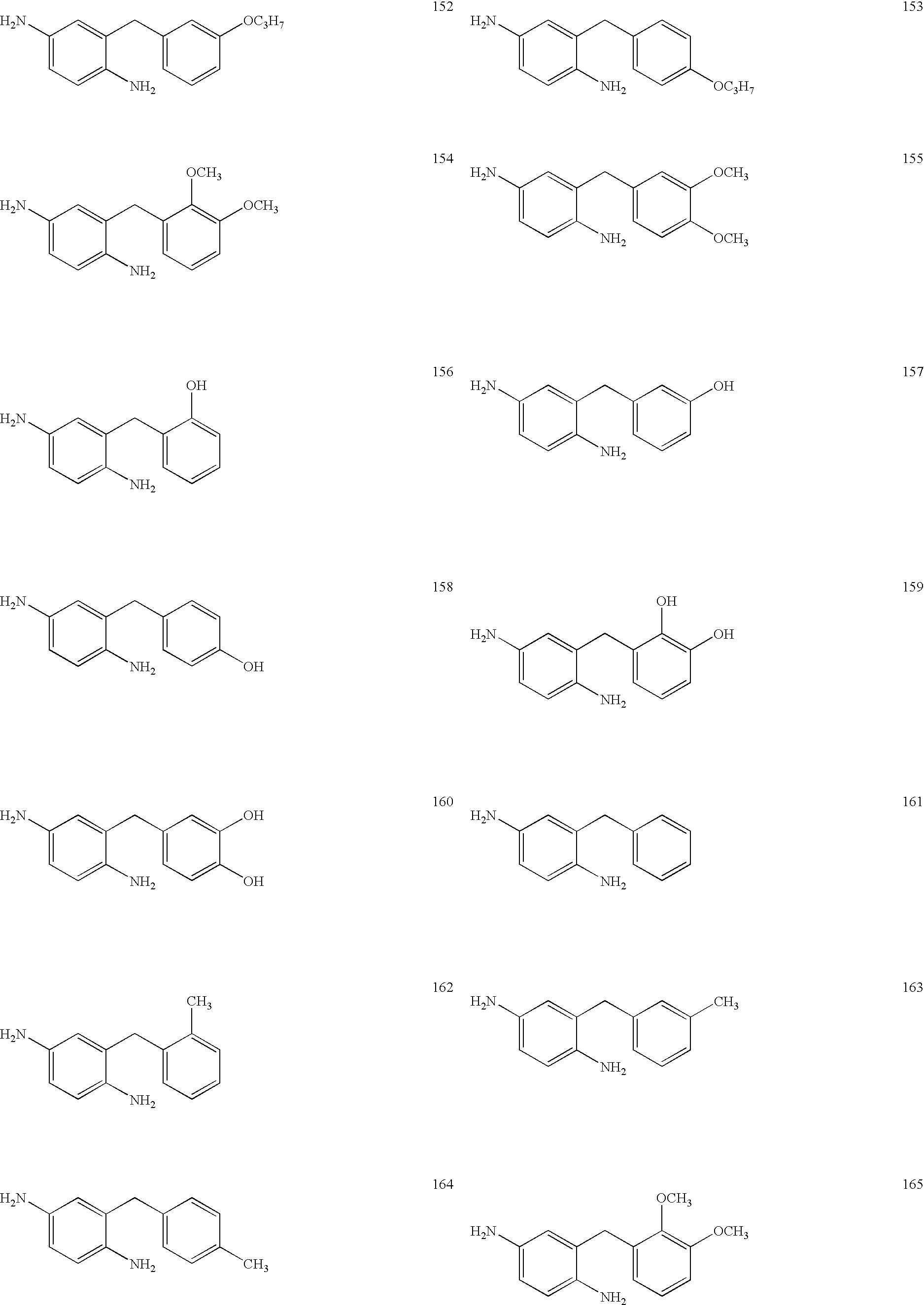

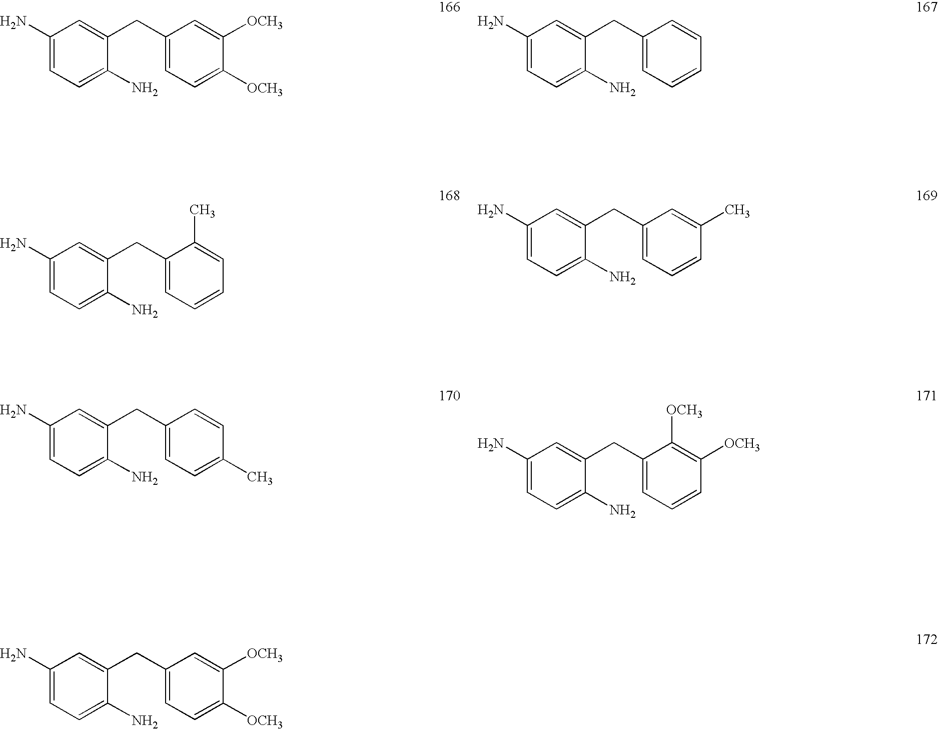

Of these, a nanoimprinting composition including a polyamic acid (B) synthesized using 4,4′-diaminodiphenylsulfone, 3,3′-diaminodiphenylsulfone, 4,4′-diaminodiphenyl ether, 4,4′-diaminodiphenylmethane, 3,3′-diaminodiphenylmethane, 2,2-bis[4-(4-aminophenoxy)phenyl]hexafluoropropane, or a compound expressed by Formula (b) allows a relief pattern with better transparency to be formed, and is therefore preferable when used in a display application that requires transparency.

These diamines can be used singly or in combinations of two or more compounds. Also, other diamine can be used instead, as long as the object of the invention is achieved.

1.2. Compound Having Two or More Acid Anhydride Groups Used to Synthesize the Polyamic Acid (B)

Specific examples of the compound having two or more acid anhydride groups used to synthesize the polyamic acid (B) in the invention include styrene/maleic anhydride copolymers, copolymers of maleic anhydride and another radical polymerizable monomer such as methyl methacrylate/maleic anhydride copolymers, 4-(2,5-dioxotetrahydrofuran-3-yl)-1,2,3,4-tetrahydronaphthalene-1,2-dicarboxylic anhydride, 5-(2,5-dioxotetrahydrofuryl)-3-methyl-3-cyclohexene-1,2-dicarboxylic anhydride, and compounds expressed by the following Formulas (173) to (219).

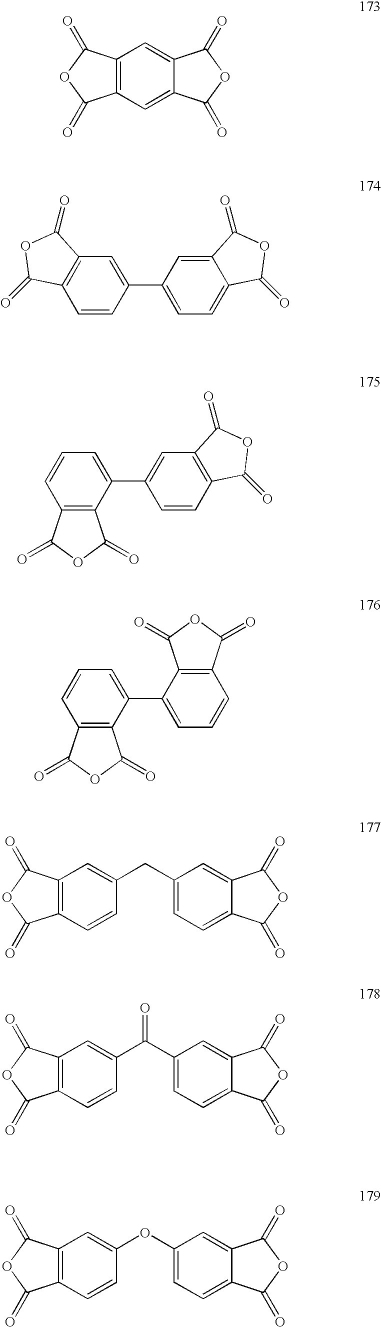

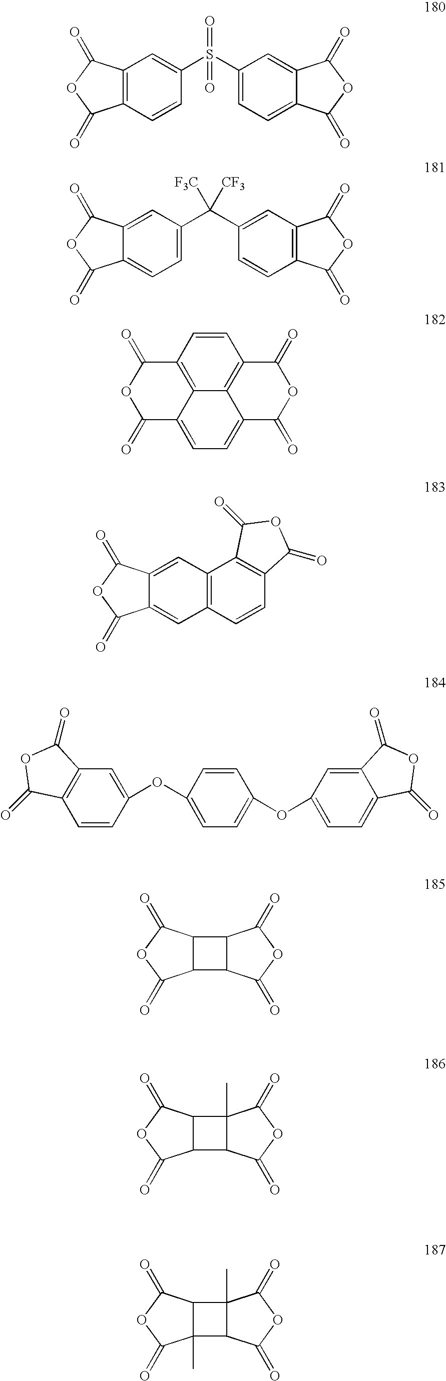

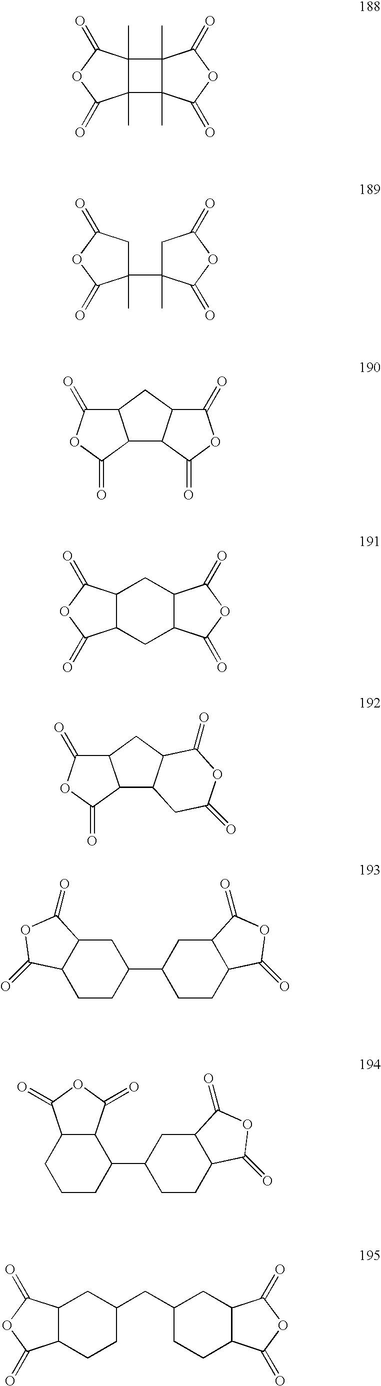

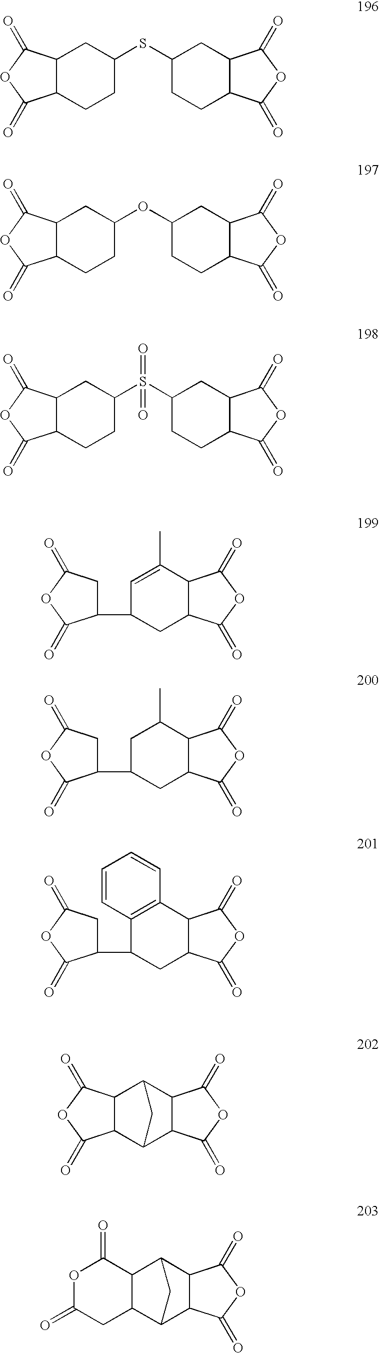

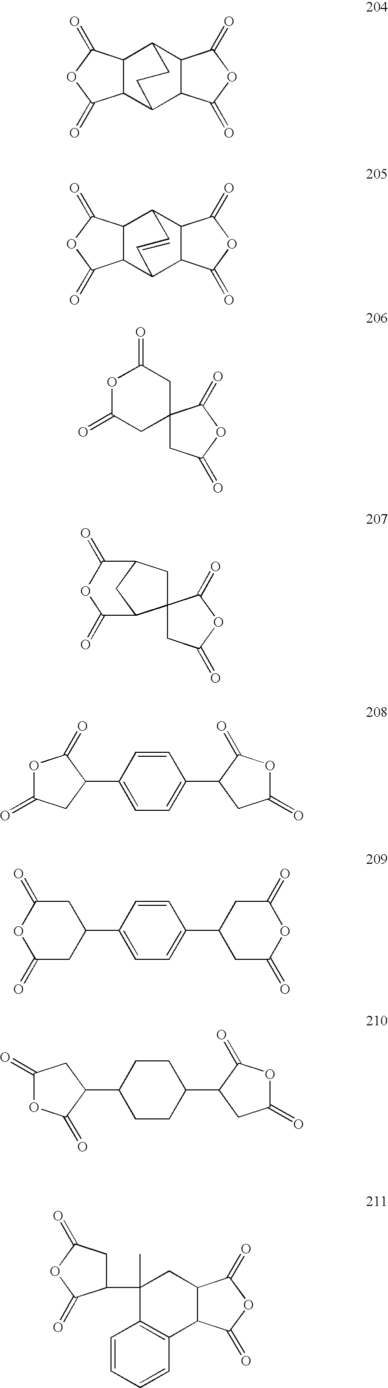

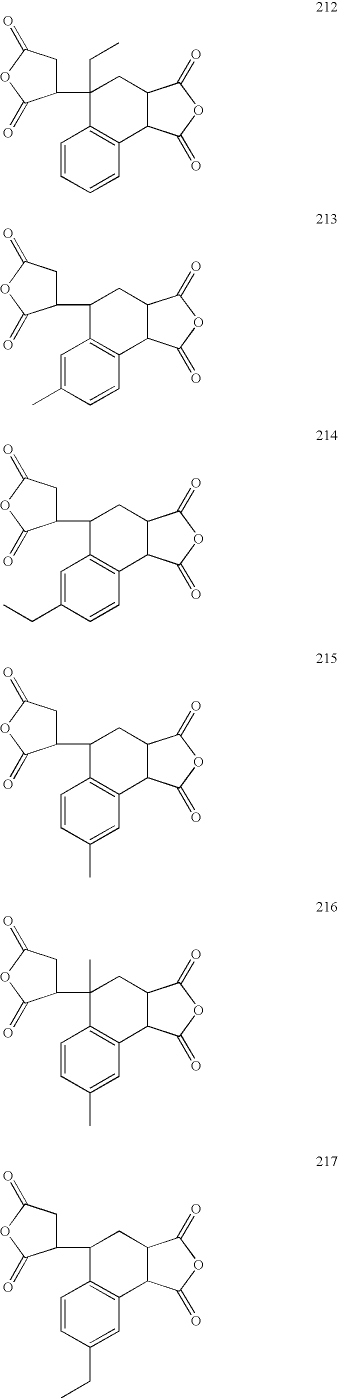

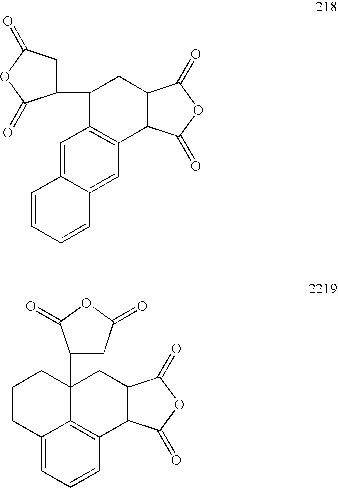

Of the specific examples of compounds having acid anhydride groups expressed by the above Formulas (173) to (219) and used to synthesize the polyamic acid (B), the use of compounds expressed by Formulas (179), (180), (181), (185), and (189) is preferable because these allow the manufacture of a nanoimprinting composition with which a good relief pattern can be formed, and using acid anhydrides of these compounds is preferable in display applications because these allow the manufacture of a composition with good transparency.

The compounds having acid anhydride group listed above may be used singly or in combinations of two or more compounds.

1.3. Additives Added to Polyamic Acid (B)

When the polyamic acid (B) used in the invention has acid anhydride groups at its molecular terminals, a monohydric alcohol can be added and reacted as needed. A nanoimprinting composition including a polyamic acid (B) to which a monohydric alcohol has been added is preferable because of its better flatness, for example.

Examples of monohydric alcohols that can be added include methanol, ethanol, 1-propanol, isopropyl alcohol, allyl alcohol, benzyl alcohol, hydroxyethyl methacrylate, propylene glycol monoethyl ether, propylene glycol monomethyl ether, dipropylene glycol monoethyl ether, dipropylene glycol monomethyl ether, ethylene glycol monoethyl ether, ethylene glycol monomethyl ether, diethylene glycol monoethyl ether, phenol, borneol, maltol, linalol, terpineol, dimethylbenzylcarbinol, ethyl lactate, glycidol, and 3-ethyl-3-hydroxymethyloxetane.

From the standpoint of increasing the flatness of the resulting overcoat film, for example, of the specific examples of monohydric alcohols given above, isopropyl alcohol, allyl alcohol, benzyl alcohol, hydroxyethyl methacrylate, propylene glycol monoethyl ether, and 3-ethyl-3-hydroxymethyloxetane are preferable, and of these, benzyl alcohol is especially favorable.

Also, 3-aminopropyltrimethoxysilane, 3-aminopropyltriethoxysilane, 3-aminopropylmethyldimethoxysilane, 3-aminopropylmethyldiethoxysilane, 4-aminobutyltrimethoxysilane, 4-aminobutyltriethoxysilane, 4-aminobutylmethyldimethoxysilane, p-aminophenyltrimethoxysilane, p-aminophenyltriethoxysilane, p-aminophenylmethyl dimethoxysilane, p-aminophenylmethyldiethoxysilane, m-aminophenyltrimethoxysilane, m-aminophenylmethyldiethoxysilane, or another such silicon-containing monoamine is preferably reacted with a polyamic acid (B) having an acid anhydride group at its molecular terminal, because this will improve the chemical resistance of the coating film that is obtained, for example.

A monohydric alcohol and a silicon-containing monoamine can also be simultaneously added to and reacted with a polyamic acid (B).

1.4. Reaction Conditions

The polyamic acid (B) is preferably obtained by reacting approximately 0.8 to approximately 1.2 mol of an anhydride of a compound having two or more acid anhydride groups with approximately 1 mol of the amino groups of a diamine. It is even better if the polyamic acid (B) is obtained by reacting approximately 0.9 to approximately 1.1 mol of an anhydride of a compound having two or more acid anhydride groups with approximately 1 mol of the amino groups of a diamine.

There are no particular restrictions on the solvent used to obtain the polyamic acid (B), as long as it allows this compound to be synthesized, but examples include diethylene glycol dimethyl ether, diethylene glycol diethyl ether, diethylene glycol methylethyl ether, diethylene glycol monoethyl ether acetate, ethylene glycol monoethyl ether acetate, propylene glycol monomethyl ether acetate, methyl 3-methoxypropionate, ethyl 3-ethoxypropionate, cyclohexanone, N-methyl-2-pyrrolidone, and N,N-dimethylacetamide. Of these, the use of propylene glycol monomethyl ether acetate, methyl 3-methoxypropionate, diethylene glycol methyl ether, and N-methyl-2-pyrrolidone is preferred.

These solvents can be used alone or as a mixture of two or more kinds of solvent. Solvents other than those listed above can also be admixed, but these other solvents preferably do not used for more than approximately 30 wt %.

It is preferable for the solvent to be used in an amount of at least approximately 100 weight parts per combined approximately 100 weight parts of the diamine and the acid anhydride, because the reaction will proceed more smoothly. The reaction is preferably conducted at approximately 40 to approximately 200° C. for approximately 0.2 to approximately 20 hours.

If a silicon-containing monoamine is added to and reacted with the polyamic acid (B), it is preferable to add the silicon-containing monoamine after the reaction between the diamine (a2) and the acid anhydride group has concluded, and after the reaction solution has cooled to approximately 40° C. or lower, and for the reaction to be conducted at approximately 10 to approximately 40° C. for approximately 0.1 to approximately 6 hours.

Furthermore, monohydric alcohol can also be added to and reacted with the polyamic acid (B).

There are no particular restrictions on the order in which the reaction raw materials are added to the reaction system. Specifically, the diamine (a2) and the acid anhydride can be added simultaneously to a reaction solvent, or the acid anhydride can be added after the diamine has been dissolved in the reaction solvent, or the diamine can be added after the acid anhydride has been dissolved in the reaction solvent.

2. Epoxy Resin (C)

The nanoimprinting composition of the invention includes an epoxy resin (C).

There are no particular restrictions on the epoxy resin (C) used in the invention, as long as it has epoxy groups, but a compound having two or more oxirane groups is preferable.

There are no particular restrictions on the concentration of the epoxy resin in the nanoimprinting composition in the invention, but approximately 1 to approximately 50 wt % is preferable, and approximately 2 to approximately 40 wt % is even better. If the concentration is within these ranges, the nanoimprinting composition will tend to have better heat resistance and chemical resistance, and will tend to form a better relief pattern.

Specific examples of the epoxy resin (C) include Bisphenol A-type epoxy resins, glycidyl ester-type epoxy resins, alicyclic epoxy resins, polymers of monomers having oxirane groups, and copolymers of monomers having oxirane groups and other monomers.

Specific examples of these epoxy resins include Epikote 807™, Epikote 815™, Epikote 825™, Epikote 827™, Epikote 828™, which is a compound expressed by the above-mentioned Formula (223), Epikote 190P™, Epikote 191P™ (Yuka Shell Epoxy); Epikote 1004™, Epikote 1256™, which are products by (Japan Epoxy Resins Co., Ltd); Araldite CY177™, Araldite CY184™, which is a compound expressed by the above-mentioned Formula (220) (Ciba-Geigy Japan); Celloxide 2021P™, which is a compound expressed by the above-mentioned Formula (221), and EHPE-3150™ (Daicel Chemical Industries); and Techmore VG3101L™, which is a compound expressed by the above-mentioned Formula (222) (Mitsui Chemical).

Of these, Epikote 828™, which is a mixture of compounds expressed by Formula (223), Araldite CY184™, which is a compound expressed by Formula (220) (Ciba-Geigy Japan), and Celloxide 2021P™, which is a compound expressed by Formula (221) (Daicel Chemical Industries) are preferable because these allow the manufacture of a composition with good transparency, and allow the manufacture of a nanoimprinting composition with which a good relief pattern can be formed.

Specific examples of monomers having oxirane groups include glycidyl (meth)acrylate, 3,4-epoxycyclohexyl (meth)acrylate, and methylglycidyl (meth)acrylate.

Specific examples of the other monomers copolymerized with the monomers having oxirane groups include (meth)acrylic acid, methyl (meth)acrylate, ethyl (meth)acrylate, isopropyl (meth)acrylate, butyl (meth)acrylate, iso-butyl (meth)acrylate, t-butyl (meth)acrylate, cyclohexyl (meth)acrylate, benzyl (meth)acrylate, 2-hydroxyethyl (meth)acrylate, 2-hydroxypropyl (meth)acrylate, styrene, methylstyrene, chloromethylstyrene, (3-ethyl-3-oxetanyl)methyl (meth)acrylate, N-cyclohexylmaleimide, and N-phenylmaleimide.

Specific preferred examples of polymers of monomers having oxirane groups include polyglycidyl methacrylate. Specific preferred examples of copolymers of monomers having oxirane groups and other monomers include copolymers of methyl methacrylate and glycidyl methacrylate, copolymers of benzyl methacrylate and glycidyl methacrylate, copolymers of butyl methacrylate and glycidyl methacrylate, copolymers of 2-hydroxyethyl methacrylate and glycidyl methacrylate, copolymers of (3-ethyl-3-oxetanyl)methyl methacrylate and glycidyl methacrylate, and copolymers of styrene and glycidyl methacrylate.

3. Polyester-Polyamic Acid (A1)

The polyester-polyamic acid (A1) is a compound having structural units expressed by General Formulas (1) and (2). The terminals of the polyester-polyamic acid (A1) are constituted, for example, by an acid anhydride group, amino, hydroxy, or the like.

There are no particular restrictions on R¹, R², and R³ in Formulas (1) and (2) as long as each is a C₂ to C₁₀₀ organic group.

In general, the higher the molecular weight of the polyester-polyamic acid (A1), the better the chemical resistance of the film obtained from the nanoimprinting composition of the invention, and the lower the molecular weight of the polyester-polyamic acid (A1), the better the solubility in solvents. As such, the weight average molecular weight of the polyester-polyamic acid (A1) contained in the nanoimprinting composition of the invention is preferably approximately 1,000 to approximately 200,000, and more preferably approximately 2,000 to approximately 150,000.

There are no particular restrictions on the concentration of the polyester-polyamic acid (A1) in the nanoimprinting composition of the invention, but approximately 1 to approximately 50 wt % is preferable, and approximately 2 to approximately 40 wt % is more preferable. These concentration ranges are preferable because the viscosity of the nanoimprinting composition will be ideal and a coating film of uniform thickness can be formed by a variety of coating methods.

The polyester-polyamic acid (A1) used in the invention is obtained, for example, from a polyhydric hydroxy compound (a1), a diamine (a2), and a compound having two or more acid anhydride groups (a3), but the invention is not limited to this method.

In the polyester-polyamic acid (A1) obtained in this way, R¹ in the above-mentioned Formulas (1) and (2) is a residue of the compound having two or more acid anhydride groups (a3), R² in Formula (1) is a residue of the diamine (a2), and R³ in Formula (2) is a residue of the polyhydric hydroxy compound (a1).

The polyhydric hydroxy compounds (a1), diamines (a2), and compounds having two or more acid anhydride groups (a3) that can be used to obtain the polyester-polyamic acid (A1) will now be described.

3.1. Polyhydric Hydroxy Compound (a1)

Specific examples of the polyhydric hydroxy compound (a1) used in the synthesis of the polyester-polyamic acid (A1) in the invention include ethylene glycol, diethylene glycol, triethylene glycol, tetraethylene glycol, polyethylene glycol with a molecular weight of approximately 1000 or less, propylene glycol, dipropylene glycol, tripropylene glycol, tetrapropylene glycol, polypropylene glycol with a molecular weight of approximately 1000 or less, 1,2-butanediol, 1,3-butanediol, 1,4-butanediol, 1,2-pentanediol, 1,5-pentanediol, 2,4-pentanediol, 1,2,5-pentanetriol, 1,2-hexanediol, 1,6-hexanediol, 2,5-hexanediol, 1,2,6-hexanetriol, 1,2-heptanediol, 1,7-heptanediol, 1,2,7-heptanetriol, 1,2-octanediol, 1,8-octanediol, 3,6-octanediol, 1,2,8-octanetriol, 1,2-nonanediol, 1,9-nonanediol, 1,2,9-nonanetriol, 1,2-decanediol, 1,10-decanediol, 1,2,1 0-decanetriol, 1,2-dodecanediol, 1,12-dodecanediol, glycerin, trimethylolpropane, pentaerythritol, dipentaerythritol, Bisphenol A™, Bisphenol S™, Bisphenol F™, diethanolamine, triethanolamine, SEO-2™ (Nikka Chemical), SKY CHDM™ (New Japan Chemical), Rikabinol HB™ (New Japan Chemical), and compounds expressed by the following Formula (A).

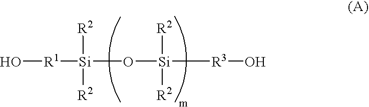

In Formula (A), R¹ and R³ are each independently —CH₂)ₓ—O—CH₂)_{y}, x and y are each independently an integer from approximately 1 to approximately 15, R² is a C₁ to C₅ alkyl, and m is an integer from approximately 2 to approximately 50.

For example, from the standpoint of improving the transparency of the resulting nanoimprinting composition, of the specific examples of the polyhydric hydroxy compound (a1) given above, ethylene glycol, diethylene glycol, triethylene glycol, tetraethylene glycol, propylene glycol, dipropylene glycol, tripropylene glycol, tetrapropylene glycol, 1,4-butanediol, 1,5-pentanediol, 1,6-hexanediol, glycerol, trimethylolpropane, pentaerythritol, and dipentaerythritol are preferred, and of these, 1,4-butanediol, 1,5-pentanediol, and 1,6-hexanediol are better yet.

3.2. Diamine (a2)

Specific examples of the diamine (a2) used to synthesize the polyester-polyamic acid (A1) in the invention are the same as those given for the diamine used to synthesize the polyamic acid (B) above, and preferred examples are also the same.

3.3. Compound Having Two or More Acid Anhydride Groups (a3)

Specific examples of the compound having two or more acid anhydride groups (a3) used to synthesize polyester-polyamic acid (A1) are the same as those given for the compound having two or more acid anhydride groups used to synthesize the polyamic acid (B) above, and preferred examples are also the same.

3.4. Additives Added to Polyester-Polyamic Acid (A1)

If the polyester-polyamic acid (A1) used in the invention has acid anhydride groups at its molecular terminals, a monohydric alcohol can be added and reacted as needed. The polyester-polyamic acid (A1) to which a monohydric alcohol has been added is preferable because of its better flatness, for example. Examples of the monohydric alcohol added here are the same as the examples of the monohydric alcohol added to the polyamic acid (B).

Also, it is preferable if a silicon-containing monoamine is added to and reacted with the polyester-polyamic acid (A1) because the chemical resistance of the resulting coating film will be improved, for example. Examples of the silicon-containing monoamine added here are the same as the examples of the silicon-containing monoamine added to the polyamic acid (B).

Also, the monohydric alcohol and the silicon-containing monoamine can be added to and reacted with the polyester-polyamic acid (A1) at the same time.

3.5. Reaction Conditions

The polyester-polyamic acid (A1) is preferably obtained by reacting approximately 0.1 to approximately 10 mol of the amino groups of the diamine (a2) and approximately 1 to approximately 10 mol of an anhydride of the compound having two or more acid anhydride groups (a3) with approximately 1 mol of the hydroxy groups of the polyhydric hydroxy compound (a1). Even more preferably, the polyester-polyamic acid (A1) is obtained by reacting approximately 0.2 to approximately 5 mol of the amino groups of the diamine (a2) and approximately 1.1 to approximately 6 mol of an anhydride of the compound having two or more acid anhydride groups (a3) with approximately 1 mol of the hydroxy groups of the polyhydric hydroxy compound (a1).

There are no particular restrictions on the solvent used to obtain the polyester-polyamic acid (A1), as long as it allows this compound to be synthesized, but the same solvents as those that can be used to obtain the polyamic acid (B) can be used, for example.

The solvent is preferably used in an amount of at least approximately 100 weight parts per approximately 100 total weight parts of the polyhydric hydroxy compound (a1), the diamine (a2), and the compound having two or more acid anhydride groups (a3), because the reaction will proceed more smoothly this way. The reaction is preferably conducted for approximately 0.2 to approximately 20 hours at approximately 40 to approximately 200° C.

If a silicon-containing monoamine is added to and reacted with the polyester-polyamic acid (A1), then it is preferable to add the silicon-containing monoamine after the reaction of the polyhydric hydroxy compound (a1), the diamine (a2), and the compound having two or more acid anhydride groups (a3) has concluded, and after the reaction solution has cooled to approximately 40° C. or lower, and to conduct the reaction for approximately 0.1 to approximately 6 hours at approximately 10 to approximately 40° C.

There are no particular restrictions on the order in which the raw materials are added to the reaction system. Specifically, the polyhydric hydroxy compound (a1), the diamine (a2), and the compound having two or more acid anhydride groups (a3) can all be added at the same time to the solvent; the diamine (a2) and the polyhydric hydroxy compound (a1) can be dissolved in the reaction solvent, after which the compound having two or more acid anhydride groups (a3) is added; the polyhydric hydroxy compound (a1) and the compound having two or more acid anhydride groups (a3) can be reacted ahead of time to synthesize a copolymer, after which the diamine (a2) is added; the diamine (a2) and the compound having two or more acid anhydride groups (a3) can be reacted ahead of time to synthesize a copolymer, after which the polyhydric hydroxy compound (a1) is added; and so on.

3.6. Polyester-Polyimide (A2)

The polyester-polyimide (A2) is a compound having structural units expressed by General Formulas (3) and (2). An acid anhydride group, amino, hydroxy, or the like is at a terminal of the polyester-polyimide (A2). R¹, R² and R³ in Formulas (3) and (2) are defined as above.

In general, the higher the molecular weight of the polyester-polyimide (A2), the better the chemical resistance of the film obtained from the nanoimprinting composition of the invention, and the lower the molecular weight of the polyester-polyimide (A2), the better the solubility in solvents. In view of this, the weight average molecular weight of the polyester-polyimide (A2) contained in the nanoimprinting composition of the invention is preferably approximately 1,000 to approximately 200,000, and more preferably approximately 2,000 to approximately 150,000.

There are no particular restrictions on the concentration of the polyester-polyimide (A2) in the nanoimprinting composition of the invention, but approximately 2 to approximately 40 wt % is preferable, and approximately 5 to approximately 30 wt % is more preferable. These concentration ranges are preferable because the viscosity of the nanoimprinting composition will be ideal and coating film of uniform thickness can be formed by a variety of coating methods.

The polyester-polyimide (A2) used in the invention is obtained, for example, by imidating the polyester-polyamic acid (A1) by heating it for approximately 20 hours at approximately 220° C. In the polyester-polyimide (A2) obtained in this manner, R¹ in the above-mentioned Formulas (2) and 3 is a residue of the compound having two or more acid anhydride groups (a3), and R² in the above-mentioned Formula (3) is a residue of the diamine (a2), and R³ in the above-mentioned Formula (2) is a residue of the polyhydric hydroxy compound (a1).

4. Additives Added to the Nanoimprinting Composition of the Invention

The nanoimprinting composition of the invention is obtained by mixing the polyamic acid (B) and the epoxy resin (C), or by mixing one or more compounds selected from the group of polyester-polyamic acids (A1) and polyester-polyimides (A2) that are imidization products thereof, and the epoxy resin (C), but depending on the desired characteristics, the nanoimprinting composition of the invention may also include a surfactant, antistatic agent, coupling agent, epoxy curing agent (such as trimellitic acid), aminosilicon compound, solvent, or other additives, and can be obtained by uniformly mixing and dissolving these components.

(1) Surfactant

If coatability is to be improved, for instance, a surfactant that meets this objective can be added. Specific examples of surfactants that can be added to the nanoimprinting composition of the invention include BYK-300™, BYK-306™, BYK-335™, BYK-310™, BYK-341™, BYK-344™, BYK-370™ (BYK Chemie), and other such silicon-based surfactants, BYK-354™, BYK-358™, BYK-361™ (BYK Chemie), and other such acrylic surfactants, and DFX-18™, Ftergent 250™, Ftergent 251™ (Neos), and other such fluorine-based surfactants.

These surfactants may be used singly or as mixtures of two or more compounds.

A surfactant is used to improve underlying substrate wettability, flatness, and coatability, and is preferably added in an amount of approximately 0.01 to approximately 1 wt % in the nanoimprinting composition.

(2) Anti-Static Agent

There are no particular restrictions on the anti-static agent added to the nanoimprinting composition of the invention, and any ordinary anti-static agent can be used, but specific examples include tin oxide, compound oxides of tin oxide and antimony oxide, compound oxides of tin oxide and indium oxide, and other such metal oxides, as well as quaternary ammonium salts.

These anti-static agents may be used singly or as a mixture of two or more compounds.

An anti-static agent is used to prevent charging, and is preferably added in an amount of approximately 0.01 to approximately 1 wt % in the nanoimprinting composition.

(3) Coupling Agent

There are no particular restrictions on the coupling agent added to the nanoimprinting composition of the invention, and any ordinary coupling agent can be used, but it is preferable to add a silane coupling agent, specific examples of which include trialkoxysilane compounds and dialkoxysilane compounds. Favorable examples include γ-vinylpropyltrimethoxysilane, γ-vinylpropyl triethoxysilane, γ-acryloylpropylmethyldimethoxysilane, γ-acryloylpropyltrimethoxysilane, γ-acryloyl propylmethyldiethoxysilane, γ-acryloylpropyltriethoxysilane, γ-methacryloylpropylmethyl dimethoxysilane, γ-methacryloylpropyltrimethoxysilane, γ-methacryloyl propylmethyldiethoxysilane, γ-methacryloylpropyltriethoxysilane, γ-glycidoxypropylmethyl dimethoxysilane, γ-glycidoxypropyl trimethoxysilane, γ-glycidoxypropylmethyldiethoxysilane, γ-glycidoxypropyltriethoxysilane, γ-aminopropylmethyldimethoxysilane, γ-aminopropyltrimethoxysilane, γ-aminopropylmethyl dimethoxysilane, γ-aminopropyltriethoxysilane, N-aminoethyl-γ-iminopropylmethyldimethoxysilane, N-aminoethyl-γ-aminopropyltrimethoxysilane, N-aminoethyl-γ-aminopropyldiethoxysilane, N-phenyl-γ-aminopropyltrimethoxysilane, N-phenyl-γ-aminopropyl triethoxysilane, N-phenyl-γ-aminopropyl methyldimethoxysilane, N-phenyl-γ-aminopropylmethyl diethoxysilane, γ-mercaptopropylmethyl dimethoxysilane, γ-aminopropyltrimethoxysilane, γ-mercaptopropylmethyldiethoxysilane, γ-mercaptopropyltriethoxysilane, γ-isocyanatopropyl methyldiethoxysilane, and γ-isocyanatopropyl triethoxysilane. Of these, γ-vinylpropyltrimethoxysilane, γ-acryloylpropyltrimethoxysilane, γ-methacryloylpropyltrimethoxysilane, γ-isocyanatopropyl triethoxysilane, and so forth are preferable.

These coupling agents may be used singly or as mixtures of two or more compounds.

The coupling agent is preferably added in an amount of approximately 0.01 to approximately 3 wt % in the nanoimprinting composition.

(4) Epoxy Curing Agent

There are no particular restrictions on the epoxy curing agent added to the nanoimprinting composition of the invention, and any ordinary epoxy curing agent can be used, but specific examples include organic acid dihydrazide compounds, imidazole and its derivatives, dicyandiamide, aromatic amines, polyvalent carboxylic acids, and polyvalent carboxylic anhydrides. More specifically, examples include dicyandiamides such as dicyandiamide, organic acid hydrazides such as dihydrazide adipate and 1,3-bis(hydrazinocarboethyl)-5-isopropylhydantoin, imidazole derivatives such as 2,4-diamino-6-[2′-ethylimidazolyl-(1′)]-ethyltriazine, 2-phenylimidazole, 2-phenyl-4-methylimidazole, 2-phenyl4-methyl-5-hydroxymethylimidazole, and acid anhydrides such as phthalic anhydride, trimellitic anhydride, 1,2,4-cyclohexanetricarboxylic acid-1,2-anhydride. Of these, trimellitic acid and 1,2,4-cyclohexanetricarboxylic acid-1,2-anhydride are preferable because they afford better transparency of the coating film that is obtained.

These epoxy curing agents may be used singly or as mixtures of two or more compounds.

The epoxy curing agent is preferably added in an amount of approximately 0.2 to approximately 5 wt % in the nanoimprinting composition.

(5) Aminosilicon Compound

An aminosilicon compound can be added to the nanoimprinting composition of the invention. Examples of aminosilicon compounds include para-aminophenyltrimethoxysilane, para-aminophenyltriethoxysilane, meta-aminophenyltrimethoxysilane, meta-aminophenyltriethoxysilane, aminopropyltrimethoxysilane, and aminopropyltriethoxysilane.

These aminosilicon compounds may be used singly or as mixtures of two or more compounds.

The aminosilicon compound is used to improve adhesion to a substrate, and is preferably added in an amount of approximately 0.05 to approximately 2 wt % in the nanoimprinting composition.

(6) Solvent

There are no particular restrictions on the solvents that can be contained in the nanoimprinting composition of the invention, as long as they are capable of dissolving the polyester-polyamic acid (A1), the polyester-polyimide (A2), the polyamic acid (B), and the epoxy resin (C). The solvent can be suitably selected as dictated by the intended use, and includes many solvents ordinarily used in the course of manufacturing soluble polyimides and other such polymer components, and in their applications.

Examples of these solvents are given below. Examples of aprotic, polar, organic solvents, which are miscible with polyamic acids and soluble polyimides, include N-methyl-2-pyrrolidone, dimethylimidazolinone, N-methylcaprolactam, N-methylpropioneamide, N,N-dimethylacetamide, dimethyl sulfoxide, N,N-dimethylformamide, N,N-diethylformamide, diethylacetamide, and γ-butyrolactone.

Examples of other solvents intended to improving coatability include alkyl lactate, 3-methyl-3-methoxybutanol, tetralin, isophorone, ethylene glycol monoalkyl ethers such as ethylene glycol monobutyl ether, diethylene glycol monoalkyl ethers such as diethylene glycol monoethyl ether, ethylene glycol monoalkyl, phenyl acetate, triethylene glycol monoalkyl ether, propylene glycol monoalkyl ethers such as propylene glycol monobutyl ether, dialkyl malonates such as diethyl malonate, dipropylene glycol monoalkyl ethers such as dipropylene glycol monomethyl ether, and acetates and other such esters of these. Of these solvents, it is particularly favorably to use N-methyl-2-pyrrolidone, dimethylimidazolinone, γ-butyrolactone, ethylene glycol monobutyl ether, diethylene glycol monoethyl ether, propylene glycol monobutyl ether, dipropylene glycol monomethyl ether, propylene glycol monomethyl ether acetate, diethylene glycol methylethyl ether, methyl 3-methoxypropionate, and so forth.

These solvents may be used singly or as mixtures of two or more compounds. The solvent is preferably added such that the solids concentration in the nanoimprinting composition will be from approximately 5 to approximately 60 wt %.

(7) Other Additives

To the extent that the characteristics of the invention are not compromised, the nanoimprinting composition of the invention can also be used as a mixture with a soluble polyimide, polyester, acrylic acid polymer, acrylate polymer, or other such polymer component (preferably within an amount of approximately 20 wt % of the nanoimprinting composition).

Also, a polyamide, which is a reaction product of a dicarboxylic acid or derivative thereof and a diamine, or a polyimide-amide, which is a reaction product of a tetracarboxylic dianhydride, a dicarboxylic acid, or a derivative thereof and a diamine, or another such polymer component can be added to the nanoimprinting composition of the invention to the extent that the object of the invention is not compromised.

5. Formation of Polymer Film

The nanoimprinting composition of the invention can be made into a coating film by coating on the surface of a substrate and then removing the solvent by heating with a hot plate, oven, or the like. The heating conditions will vary with the types of components and the proportions in which they are used, but usually a coating film is formed in approximately 5 to approximately 15 minutes when a approximately 70° C. to approximately 120° C. hot plate is used or in approximately 1 to approximately 5 minutes when a approximately 70° C. to approximately 120° C. oven is used.

Coating on the surface of a substrate with the polymer film composition can be accomplished by spin coating, roll coating, dipping, slit coating, or another ordinary method for forming a coating film.

After the coating film has been formed, for reacting carboxy groups of polyamic acid or polyester-polyamic acid with oxirane groups of epoxy resin, it is cured by being heat treated at approximately 180° C. to approximately 250° C., and preferably approximately 200° C. to approximately 240° C., for approximately 30 to approximately 90 minutes when an oven is used, or for approximately 5 to approximately 30 minutes when a hot plate is used, to yield a polymer film.

6. Nanoimprinting

A mold that has been preheated to the same temperature as the temperature during heating for obtaining a polymer film is pressed against the coating film for approximately 2 to approximately 20 minutes at a pressure of approximately 0.01 to approximately 2 kg/cm². Thereafter, the mold is removed from the coating film to form a relief pattern on the coating film.

This relief pattern is heat treated at approximately 180 to approximately 250° C., and preferably approximately 200 to approximately 240° C., for approximately 30 to approximately 90 minutes in an oven or for approximately 5 to approximately 30 minutes on a hot plate, which promotes imidation and a reaction between the carboxy groups of the polyamic acid or polyester-polyamic acid and the oxirane groups of the epoxy resin, producing a nanoimprinted relief pattern that is tough and has excellent heat resistance, chemical resistance, adhesion, and sputtering resistance.

The objects, features, advantages and ideas of the invention will be apparent to those skilled in the art from the description provided in the specification, and the invention will be readily practicable by those skilled in the art on the basis of the description appearing herein. The Description of the Preferred Embodiments and the Examples which show preferred modes for practicing the invention are included for the purpose of illustration and explanation, and are not intended to limit the scope of the claims. It will be apparent to those skilled in the art that various modifications may be made in how the invention is practiced based on described aspects in the specification without departing from the spirit and scope of the invention disclosed herein. Thus, it is intended that the invention covers the modifications and variations of this invention that come within the scope of any claims and their equivalents.

### EXAMPLES

The invention will now be described through examples and comparative examples, but is not limited to or by these examples.

The names of the diamines, tetracarboxylic dianhydrides, and solvents used in the examples and comparative examples are abbreviated as follows. These abbreviations will be used in the following descriptions.

| | |
|---|---|
| Diamines | |
| 4,4′-Diaminodiphenyl Ether | APE |
| 3,3′-Diaminodiphenylsulfone | DDS |
| Tetracarboxylic Dianhydrides: | |
| Pyromellitic Dianhydride | PMDA |
| 3,3′,4,4′-Diphenyl Ether Tetracarboxylic Dianhydride | ODPA |
| Solvent Components: | |
| N-Methyl-2-Pyrrolidone | NMP |
| γ-Butyrolactone | GBL |
| Butyl Cellosolve | BC |

### Synthesis Example 1

### Synthesis of Polyamic Acid

21.81 g of PMDA, 20.02 g of APE, and 400 g of dehydrated and purified NMP were put in a 1000 mL four-neck flask equipped with a thermometer, a stirrer, a raw material feed port, and a nitrogen gas inlet, and the contents were stirred for 30 hours at 25° C. under a dry nitrogen gas flow. 394.77 g of dehydrated and purified NMP was added to this reaction solution, and the system was stirred for 8 hours at 60° C., which gave a 5 wt % solution of polyamic acid that was transparent and pale yellow in color. The viscosity of the reaction solution was 38 mPa·s (E-type viscometer, 25° C.). The polyamic acid thus obtained was also measured by GPC, which revealed the weight average molecular weight to be 41,000.

### Synthesis Example 2

### Synthesis of Polyester-Polyamic Acid

65.00 g of ODPA, 9.44 g of 1,4-butanediol, and 111.66 g of dehydrated and purified NMP were added to a 500 mL four-neck flask equipped with a thermometer, a stirrer, a raw material feed port, and a nitrogen gas inlet, and the contents were stirred for one hour at 130° C. under a dry nitrogen gas flow. This reaction solution was cooled to 40° C., and 26.01 g of DDS, and 122.72 g of dehydrated and purified NMP were added and the contents were stirred for 2 hours at 40° C. under a dry nitrogen gas flow. Finally, 167.42 g of dehydrated and purified NMP was added and stirred, which gave a 20% solution of a pale yellow, transparent polyester-polyamic acid. The viscosity of the reaction solution was 311 mPa·s. GPC measurement revealed the weight average molecular weight to be 14,000.

### Example 1

### Preparation of Nanoimprinting Composition

The components listed below were mixed and dissolved at room temperature under a dry nitrogen gas flow.

| | |
|---|---|
| Polyamic Acid Solution of Synthesis Example 1 | 5.00 g |
| Celloxide 2021P ™ (Alicyclic Epoxy Resin made | 0.50 g |
| by Daicel Chemical Industries) | |
| BC | 2.00 g |

The solution thus obtained was filtered through a 0.2 μm membrane filter made of a fluororesin, which gave a nanoimprinting composition.

The resulting nanoimprinting composition was spin coated onto a glass substrate. The coating was performed for 10 seconds at 2,500 rpm. After coating, the film was dried for 5 minutes on an 80° C. hot plate to form a coating film with a thickness of 0.23 μm. The substrate and its attached coating film were heated for 8 minutes on a 150° C. hot plate. The heated substrate was then placed in an imprinting apparatus (X-200 made by Sciva), and a mold heated to 150° C. was pressed against the coating film for 10 minutes under a load of 0.10 kg/cm². When the mold cooled to 80° C. and was removed from the coating film, a relief pattern had been formed in which the shape of the mold was transferred to the coating film. This relief pattern was heat treated for 40 minutes in a 220° C. oven, after which the shape of the relief pattern was observed under an electron microscope at a magnification of 20,000 times, which revealed that the transferred mold shape was maintained, and no heat sag was noted.

Also, when the glass substrate with this relief pattern was immersed for 10 minutes at 40° C. in NMP, and the shape of the relief pattern was then observed under an electron microscope at a magnification of 20,000 times, the same shape as before treatment was still maintained.

### Example 2

### Preparation of Nanoimprinting Composition

The components listed below were mixed and dissolved at room temperature under a dry nitrogen gas flow.

| | |
|---|---|
| Polyester-Polyamic Acid Solution of Synthesis Example 2 | 5.00 g |
| Araldite CY184 ™ (Alicyclic Epoxy Resin made by Vantico) | 0.50 g |
| GBL | 2.00 g |
| BC | 2.00 g |

The solution thus obtained was filtered through a 0.2 μm membrane filter made of a fluororesin, which gave a nanoimprinting composition.

The resulting nanoimprinting composition was spin coated onto a glass substrate. The coating was performed for 10 seconds at 2,500 rpm. After coating, the film was dried for 5 minutes on an 80° C. hot plate to form a coating film with a thickness of 0.28 μm. The substrate and its attached coating film were heated for 7 minutes on a 140° C. hot plate. The heated substrate was then placed in an imprinting apparatus (X-200 made by Sciva), and a mold heated to 140° C. was pressed against the coating film for 10 minutes under a load of 0.05 kg/cm². When the mold cooled to 80° C. and was removed from the coating film, a relief pattern had been formed in which the shape of the mold was transferred to the coating film. This relief pattern was heat treated for 40 minutes in a 220° C. oven, after which the shape of the relief pattern was observed under an electron microscope at a magnification of 20,000 times, which revealed that the transferred mold shape was maintained, and no heat sag was noted.

Also, when the glass substrate with this relief pattern was immersed for 10 minutes at 40° C. in NMP, and the shape of the relief pattern was then observed under an electron microscope at a magnification of 20,000 times, the same shape as before treatment was still maintained.

### Comparative Example 1

### Preparation of Nanoimprinting Composition

The components listed below were mixed and dissolved at room temperature under a dry nitrogen gas flow.

| | |
|---|---|
| Polyamic Acid Solution of Synthesis Example 1 | 5.00 g |
| BC | 1.50 g |

The solution thus obtained was filtered through a 0.2 μm membrane filter made of a fluororesin, which gave a nanoimprinting composition.

The resulting nanoimprinting composition was spin coated onto a glass substrate. The coating was performed for 10 seconds at 2,500 rpm. After coating, the film was dried for 5 minutes on an 80° C. hot plate to form a coating film with a thickness of 0.25 μm. The substrate and its attached coating film were treated and a mold was pressed against the film and then cooled and removed under the same conditions as in Example 1, whereupon a relief pattern had been formed in which the shape of the mold was transferred to the coating film. This relief pattern was heat treated for 40 minutes in a 220° C. oven, after which the shape of the relief pattern was observed under an electron microscope at a magnification of 20,000 times, which revealed that the relief pattern had been eliminated by heat sag.

### Comparative Example 2

The nanoimprinting composition prepared in Comparative Example 1 was used to coat a glass substrate in the same manner as in Comparative Example 1 to form a coating film with a thickness of 0.25 μm. This substrate was then placed in an imprinting apparatus (X-200 made by Sciva), and a mold heated to 200° C. was pressed against the coating film for 60 minutes under a load of 0.05 kg/cm². When the mold cooled to 80° C. and was removed from the coating film, a relief pattern had been formed in which the shape of the mold was transferred to the coating film. This relief pattern was heat treated for 40 minutes in a 220° C. oven, after which the shape of the relief pattern was observed under an electron microscope at a magnification of 20,000 times, which revealed that the transferred mold shape was maintained. However, when the glass substrate with this relief pattern was immersed for 10 minutes at 40° C. in NMP, and the shape of the relief pattern was then examined under an electron microscope at a magnification of 20,000 times, it was found that the relief pattern had lost is shape.

### INDUSTRIAL APPLICABILITY

Examples of ways the invention can be put to use include nanoimprinting in the process of manufacturing optical devices such as an FPD, recording media, semiconductors, electronic devices, bio-chips, and chemical chips.

Although the invention has been described and illustrated with a certain degree of particularity, it is understood that the disclosure has been made only by way of example, and that numerous changes in the conditions and order of steps can be resorted to by those skilled in the art without departing from the spirit and scope of the invention.

What is claimed is:

1. A nanoimprinting composition comprising a polyamic acid (B) and an epoxy resin (C).

2. The nanoimprinting composition according to claim 1, wherein the polyamic acid (B) has structural units represented by Formula (1): 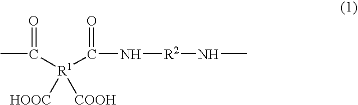
wherein R¹ and R² are each independently a C₂ to C₁₀₀ organic group.

3. The nanoimprinting composition according to claim 1, wherein the polyamic acid (B) is obtained using a diamine and a tetracarboxylic dianhydride.

4. The nanoimprinting composition according to claim 1, wherein the polyamic acid (B) is obtained using one or more diamines selected from the group of 4,4′-diaminodiphenylsulfone, 3,3′-diaminodiphenylsulfone, 3,4′-diaminodiphenylsulfone, bis[4-(4-aminophenoxy)phenyl]sulfone, bis[4-(3-aminophenoxy)phenyl]sulfone, bis[3-(4-aminophenoxy)phenyl]sulfone, [4-(4-aminophenoxy)phenyl][3-(4-aminophenoxy)phenyl]sulfone, [4-(3-aminophenoxy)phenyl][3-(4-aminophenoxy)phenyl]sulfone, 4,4′-diaminodiphenyl ether, 4,4′-diaminodiphenylmethane, 3,3′-diaminodiphenylmethane, 3,3′-dimethyl-4,4′-diaminodiphenylmethane, 2,2-bis[4-(4-aminophenoxy)phenyl]propane, 2,2-bis[4-(4-aminophenoxy)phenyl]hexafluoropropane, and compounds represented by Formula (b): 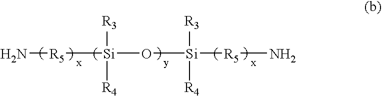
wherein R₃ and R₄ are each independently a C₁ to C₃ alkyl or phenyl, each R₅ is independently a methylene, phenylene, or alkyl-substituted phenylene, each x is independently an integer from approximately 1 to approximately 6, and y is an integer from approximately 1 to approximately 100;
with one or more tetracarboxylic dianhydrides selected from the group of pyromellitic dianhydride, 1,2,3,4-cyclobutanetetracarboxylic dianhydride, 1,2,3,4-butanetetracarboxylic dianhydride, 1,2,4,5-cyclohexanetetracarboxylic dianhydride, 3,3′,4,4′-diphenyl ether tetracarboxylic dianhydride, and 3,3′,4,4′-diphenylsulfonetetracarboxylic dianhydride.

5. The nanoimprinting composition according to claim 1, wherein the epoxy resin (C) is one or more compounds selected from the group of compounds represented by Formulas (220) to (223): 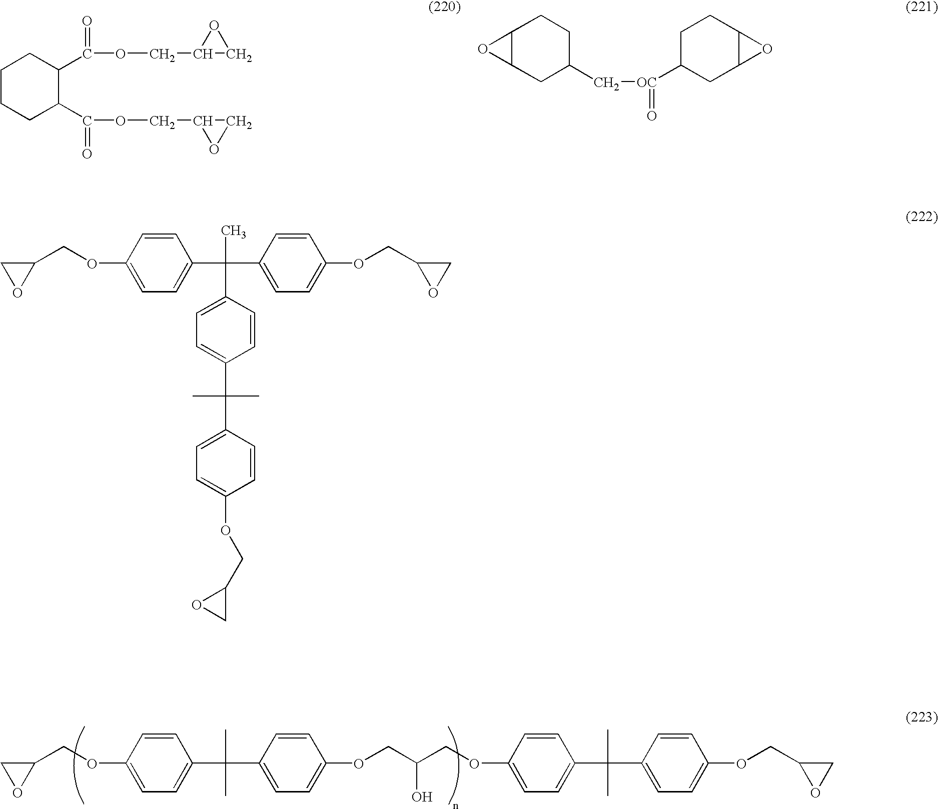
wherein n is an integer from approximately 0 to approximately 10.

6. The nanoimprinting composition according to claim 1, wherein the polyamic acid (B) is contained in an amount of approximately 1 to approximately 50 wt %, and the epoxy resin (C) is contained in an amount of approximately 1 to approximately 50 wt %.

7. A nanoimprinting composition, comprising approximately 2 to approximately 40 wt % a polyamic acid (B) obtained by reacting one or more diamines selected from the group of 4,4′-diaminodiphenylsulfone, 3,3′-diaminodiphenylsulfone, 4,4′-diaminodiphenyl ether, 4,4′-diaminodiphenylmethane, 3,3′-diaminodiphenylmethane, 2,2-bis[4-(4-aminophenoxy)phenyl]hexafluoropropane, and compounds represented by Formula (b): 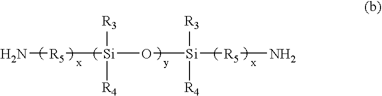
wherein R₃ and R₄ are each independently a C₁ to C₃ alkyl or phenyl, each R₅ is independently a methylene, phenylene, or alkyl-substituted phenylene, each x is independently an integer from approximately 1 to approximately 6, and y is an integer from approximately 1 to approximately 100;
with one or more tetracarboxylic dianhydrides selected from the group of pyromellitic dianhydride, 1,2,3,4-butanetetracarboxylic dianhydride, 3,3′,4,4′-diphenyl ether tetracarboxylic dianhydride, and 3,3′,4,4′-diphenylsulfonetetracarboxylic dianhydride;
and approximately 2 to approximately 40 wt % of one or more epoxy resins (C) selected from the group of compounds represented by Formulas (220) to (223): 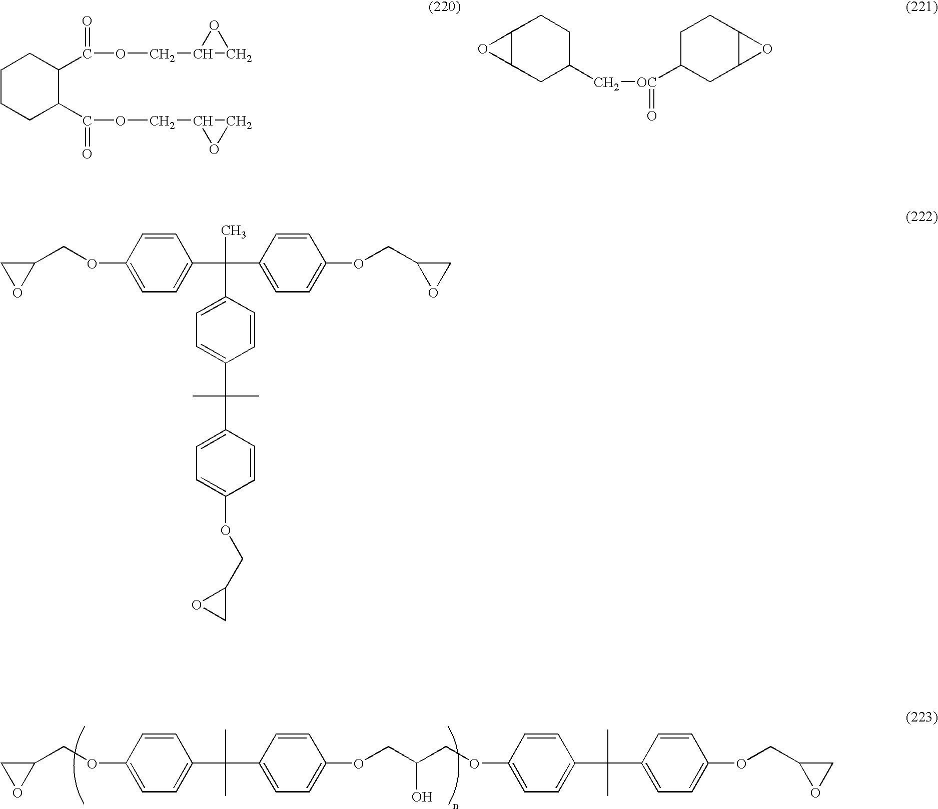
wherein n is an integer from approximately 0 to approximately 10.

8. A nanoimprinting composition comprising one or more compounds selected from the group of polyester-polyamic acids (A1) having structural units represented by Formulas (1) and (2): 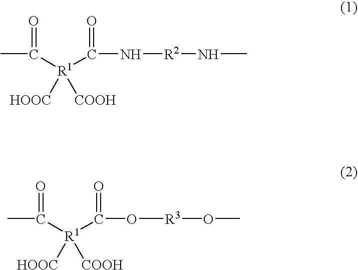
wherein R¹, R², and R³ are each independently a C₂ to C₁₀₀ organic group;
and polyester-polyimides (A2) having structural units represented by Formulas (3) and (2): 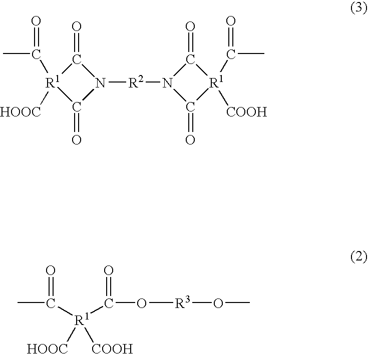
wherein R¹, R², and R³ are each independently a C₂ to C₁₀₀ organic group; and
an epoxy resin (C).

9. A nanoimprinting composition comprising one or more compounds selected from the group of polyester-polyamic acids (A1) obtained using a polyhydric hydroxy compound (a1), a diamine (a2) and a compound having two or more acid anhydride groups (a3), and polyester-polyimides (A2) that are imidization products thereof, and an epoxy resin (C).

10. The nanoimprinting composition according to claim 9, wherein the polyester-polyamic acid (A1) has structural units represented by Formulas (1) and (2): 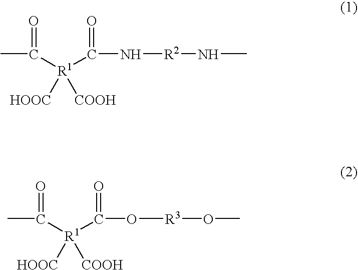
wherein R¹, R², and R³ are each independently a C₂ to C₁₀₀ organic group.

11. The nanoimprinting composition according to claim 9, wherein the polyester-polyimides (A2) have structural units represented by Formulas (3) and (2): 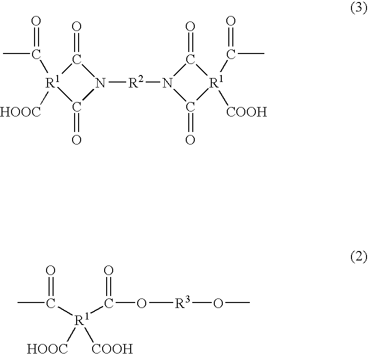
wherein R¹, R², and R³ are each independently a C₂ to C₁₀₀ organic group.

12. The nanoimprinting composition according to claim 9, wherein the compound having two or more acid anhydride groups (a3) is one or more compounds selected from the group of tetracarboxylic dianhydrides and a copolymer of a polymerizable monomer having an acid anhydride group and at least one other polymerizable monomer.

13. The nanoimprinting composition according to claim 12, wherein the polymerizable monomer having an acid anhydride group is maleic anhydride.

14. The nanoimprinting composition according to claim 12, wherein the at least one other polymerizable monomer is one or more compounds selected from the group of styrene, methyl (meth)acrylate, butyl (meth)acrylate, 2-hydroxyethyl (meth)acrylate, benzyl (meth)acrylate, cyclohexyl (meth)acrylate, N-cyclohexyl maleimide, and N-phenylmaleimide.

15. The nanoimprinting composition according to claim 12, wherein the copolymer of the polymerizable monomer having an acid anhydride group and the at least one other polymerizable monomer is a copolymer of styrene and maleic anhydride.

16. The nanoimprinting composition according to claim 9, wherein the polyhydric hydroxy compound (a1) is one or more compounds selected from the group of ethylene glycol, diethylene glycol, triethylene glycol, tetraethylene glycol, propylene glycol, dipropylene glycol, tripropylene glycol, tetrapropylene glycol, 1,4-butanediol, 1,5-pentanediol, 1,6-hexanediol, glycerol, trimethylolpropane, pentaerythritol, and dipentaerythritol;
wherein the diamine (a2) is one or more compounds selected from the group of 4,4′-diaminodiphenylsulfone, 3,3′-diaminodiphenylsulfone, 3,4′-diaminodiphenylsulfone, bis[4-(4-aminophenoxy)phenyl]sulfone, bis[4-(3-aminophenoxy)phenyl]sulfone, bis[3-(4-aminophenoxy)phenyl]sulfone, [4-(4-aminophenoxy)phenyl][3-(4-aminophenoxy)phenyl]sulfone, [4-(3-aminophenoxy)phenyl][3-(4-aminophenoxy)phenyl]sulfone, 4,4′-diaminodiphenyl ether, 4,4′-diaminodiphenylmethane, 3,3′-diaminodiphenylmethane, 3,3′-dimethyl4,4′-diaminodiphenylmethane, 2,2-bis[4-(4-aminophenoxy)phenyl]propane, 2,2-bis[4-(4-aminophenoxy)phenyl]hexafluoropropane, and compounds represented by Formula (b): 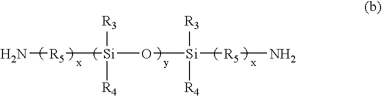
wherein R₃ and R₄ are each independently a C₁ to C₃ alkyl or phenyl, each R₅ is independently a methylene, phenylene, or alkyl-substituted phenylene, each x is independently an integer from approximately 1 to approximately 6, and y is an integer from approximately 1 to approximately 100; and
wherein the compound having two or more acid anhydride groups (a3) is one or more compounds selected from the group of styrene/maleic anhydride copolymers, pyromellitic dianhydride, 1,2,3,4-cyclobutanetetracarboxylic dianhydride, 1,2,3,4-butanetetracarboxylic dianhydride, 1,2,4,5-cyclohexanetetracarboxylic dianhydride, 3,3′,4,4′-diphenyl ether tetracarboxylic dianhydride, and 3,3′,4,4′-diphenylsulfonetetracarboxylic dianhydride.

17. The nanoimprinting composition according to claim 9, wherein the polyhydric hydroxy compound (a1) is one or more compounds selected from the group of 1,4-butanediol, 1,5-pentanediol, and 1,6-hexanediol;
wherein the diamine (a2) is one or more compounds selected from the group of 3,3′-diaminodiphenylsulfone, 4,4′-diaminodiphenyl ether, 4,4′-diaminodiphenylmethane, and compounds represented by Formula (b): 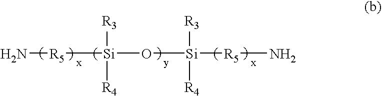
wherein R₃ and R₄ are each independently a C₁ to C₃ alkyl or phenyl, each R₅ is independently a methylene, phenylene, or alkyl-substituted phenylene, each x is independently an integer from approximately 1 to approximately 6, and y is an integer from approximately 1 to approximately 100; and
wherein the compound having two or more acid anhydride groups (a3) is one or more compounds selected from the group of styrene/maleic anhydride copolymers, 3,3′,4,4′-diphenyl ether tetracarboxylic dianhydride, 3,3′,4,4′-diphenylsulfonetetracarboxylic dianhydride, and butanetetracarboxylic dianhydride.

18. The nanoimprinting composition according to claim 9, wherein the polyester-polyamic acid (A1) or polyester-polyimides (A2) is obtained by reacting approximately 0.1 to approximately 10 mol of the amino groups of a diamine (a2) and approximately 1 to approximately 10 mol of an anhydride of a compound having two or more acid anhydride groups (a3) with approximately 1 mol of the hydroxy groups of a polyhydric hydroxy compound (a1).

19. The nanoimprinting composition according to claim 8, wherein the epoxy resin (C) is one or more compounds selected from the group of compounds represented by Formulas (220) to (223): 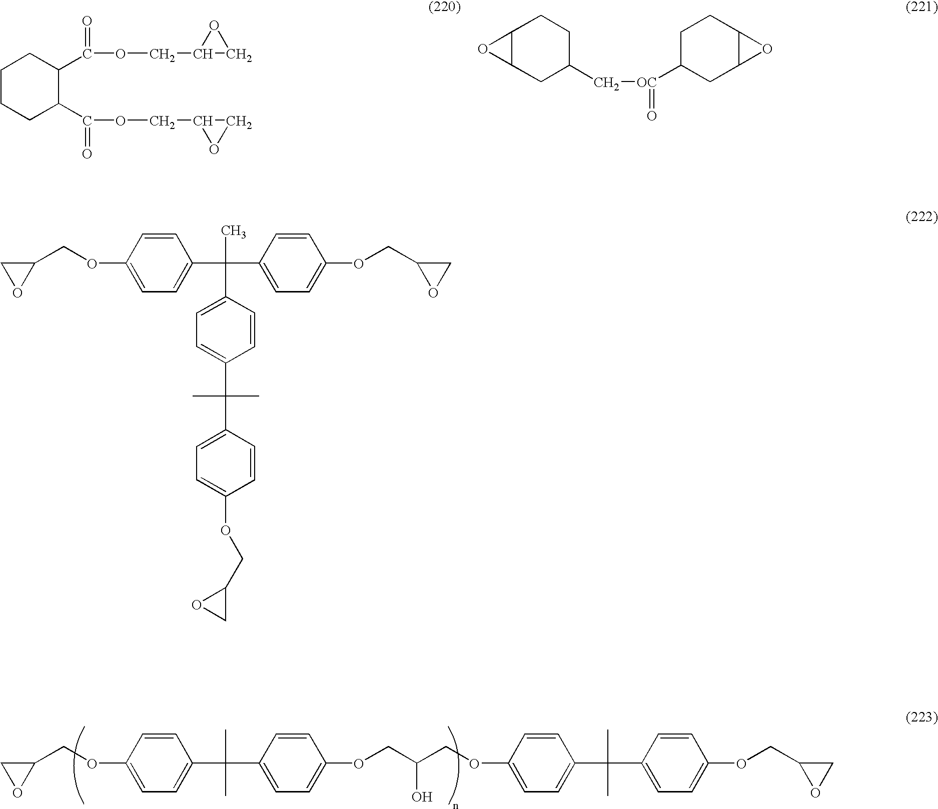
wherein n is an integer from approximately 0 to approximately 10.

20. The nanoimprinting composition according to claim 8, comprising at least one of the polyester-polyamic acid (A1) and the polyester-polyimide (A2) in an amount of approximately 1 to approximately 50 wt % and the epoxy resin (C) in an amount of approximately 1 to approximately 50 wt %.

21. A nanoimprinting composition, comprising approximately 2 to approximately 40 wt % of a polyester-polyamic acid (A1) or polyester-polyimide (A2) obtained by reacting at least one compound of polyhydric hydroxy compound (a1) selected from the group of diethylene glycol, 1,4-butanediol, and trimethylolpropane, at least one compound of diamine (a2) selected from the group consisting of 4,4′-diaminodiphenylsulfone, 4,4′-diaminodiphenyl ether, 4,4′-diaminodiphenylmethane and compounds expressed by Formula (b), and a compound having two or more of at least one compound of acid anhydride group (a3) selected from the group of styrene/maleic anhydride copolymers, pyromellitic dianhydride, 1,2,3,4-butanetetracarboxylic dianhydride, 3,3′,4,4′-diphenyl ether tetracarboxylic dianhydride, and 3,3′,4,4′-diphenylsulfonetetracarboxylic dianhydride, and at least one epoxy resin of approximately 2 to approximately 40 wt % (C) selected from the group of compounds represented by Formulas (220) to (223): 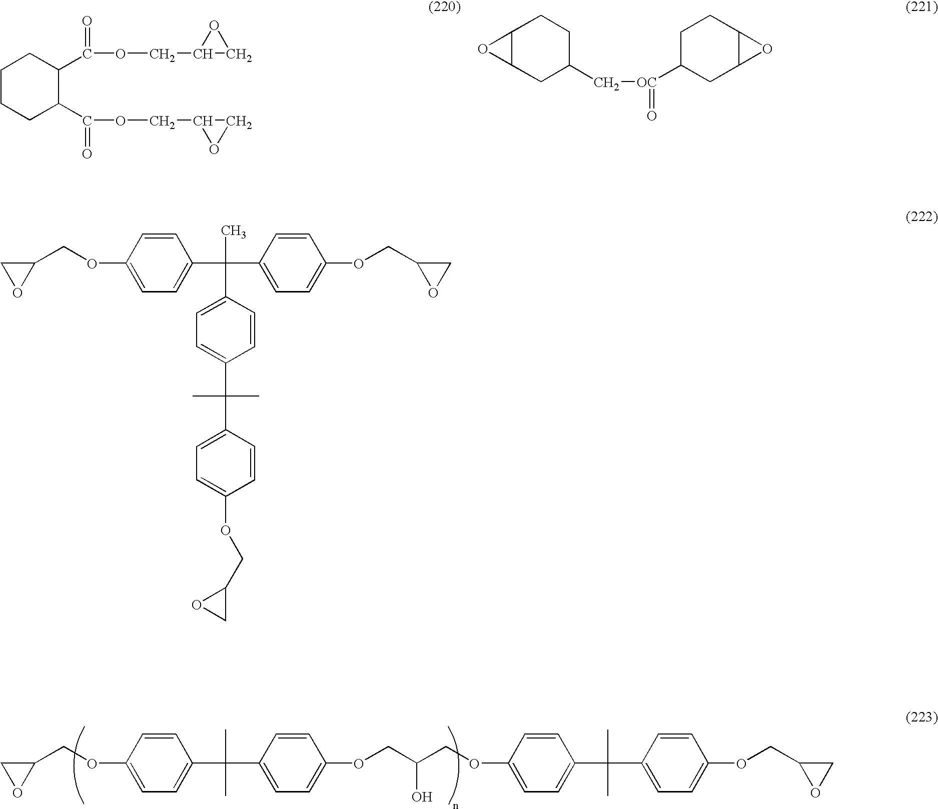
wherein n is an integer from approximately 0 to approximately 10.

22. The nanoimprinting composition according to claim 8, further comprising a polyamic acid (B).
